(19) United States
(12) Patent Application Publication
(10) Pub. No.: US 2023/0289701 A1
(43) Pub. Date: Sep. 14, 2023

(54) SYSTEMS AND METHODS FOR ASSESSMENT OF ORGANIZATION CULTURE AND READINESS FOR REMOTE WORK

(71) Applicant: WorkplaceUX LLC, Weston, CT (US)

(72) Inventors: Thomas P. Bradbury, Weston, CT (US); Stefan Dietrich, San Francisco, CA (US)

(21) Appl. No.: 18/049,561

(22) Filed: Oct. 25, 2022

Related U.S. Application Data
(60) Provisional application No. 63/271,299, filed on Oct. 25, 2021.

(51) Int. Cl. G06Q 10/0639; G06N 3/08

(52) U.S. Cl. CPC G06Q 10/06395; G06N 3/08

(57) ABSTRACT

The present disclosure may provide methods, systems, and apparatuses for training a remote workplace culture assessment model comprising a neural network. An assessment may be sent to a user device corresponding to a user of a workplace. The assessment may include a test statement. A user response to the test statement may be received. The user response and test statement may be applied to the remote workplace culture assessment model, thereby yielding a statement strength, a statement correlation, and a remote workplace culture profile. The weighting input of the remote workplace culture assessment model may be changed based on the statement strength and the statement correlation, thereby training the remote workplace culture assessment model.

### CROSS REFERENCE TO RELATED APPLICATIONS

This application claims priority to U.S. Provisional Application No. 63/271,299, filed on 25 Oct. 2021, the entire disclosure of which is hereby incorporated by reference.

### BACKGROUND

Forced change in workplaces is bringing major shifts to worker needs, and flexible working is considered more of a factor in a post-COVID-19 era than before. Employers face major internal politics, employees feeling less dependent upon a singular employer, and a constant talent war. A business's needs for a core office may increase pressure for a physical presence of employees in the workplace. A blanket approach may be taken conventionally, where business managers determine a remote work policy.

Businesses able to adapt to changing marketplace conditions may find greater success in the marketplace. Not correctly determining the best remote work policy for a given business or department within a business may be to the detriment of the business. Therefore, improved methods of determining a business's remote work culture and capability is needed.

### SUMMARY

This Summary is intended to introduce, in an abbreviated form, various topics to be elaborated upon below in the Detailed Description. This Summary is not intended to identify key or essential aspects of the claimed invention. This Summary is similarly not intended for use as an aid in determining the scope of the claims.

In some aspects, the techniques described herein relate to a method of training a remote workplace culture assessment model, including, using a processor of an application server: providing the remote workplace culture assessment model including a neural network including a logical connection connecting: a user response input; a test statement input; a weighting input; a statement strength output; a statement correlation output; a remote workplace culture profile output; and wherein the neural network is configured to be trained by changing the weighting input; sending an assessment to a user device corresponding to a user of a workplace, the assessment including a test statement; receiving, from the user device, a user response to the test statement; applying the user response to the user response input of the remote workplace culture assessment model and the test statement to the test statement input of the remote workplace culture assessment model, thereby yielding a statement strength at the statement strength output, a statement correlation at the statement correlation output, and a remote workplace culture profile at the remote workplace culture profile output; and changing the weighting input of the remote workplace culture assessment model based on the statement strength and the statement correlation, thereby training the remote workplace culture assessment model.

In some aspects, the techniques described herein relate to a system for training a remote workplace culture assessment model, including: a processor of an application server; and an electronic storage device in electronic communication with the processor, the electronic storage device having a database stored thereon; wherein the processor is configured to perform a method including: provide the remote workplace culture assessment model including a neural network including a logical connection connecting: a user response input; a test statement input; a weighting input; a statement strength output; a statement correlation output; a remote workplace culture profile output; and wherein the neural network is configured to be trained by changing the weighting input; send an assessment to a user device corresponding to a user of a workplace, the assessment including a test statement; receive, from the user device, a user response to the test statement; apply the user response to the user response input of the remote workplace culture assessment model and the test statement to the test statement input of the remote workplace culture assessment model, thereby yielding a statement strength at the statement strength output, a statement correlation at the statement correlation output, and a remote workplace culture profile at the remote workplace culture profile output; and change the weighting input of the remote workplace culture assessment model based on the statement strength and the statement correlation, thereby training the remote workplace culture assessment model.

In some aspects, the techniques described herein relate to a tangible, non-transient, computer-readable media having instructions thereupon which when implemented by a processor cause the processor to perform a method for training a remote workplace culture assessment model, the method including: providing the remote workplace culture assessment model including a neural network including a logical connection connecting: a user response input; a test statement input; a weighting input; a statement strength output; a statement correlation output; a remote workplace culture profile output; and wherein the neural network is configured to be trained by changing the weighting input; sending an assessment to a user device corresponding to a user of a workplace, the assessment including a test statement; receiving, from the user device, a user response to the test statement; applying the user response to the user response input of the remote workplace culture assessment model and the test statement to the test statement input of the remote workplace culture assessment model, thereby yielding a statement strength at the statement strength output, a statement correlation at the statement correlation output, and a remote workplace culture profile at the remote workplace culture profile output; and changing the weighting input of the remote workplace culture assessment model based on the statement strength and the statement correlation, thereby training the remote workplace culture assessment model.

### BRIEF DESCRIPTION OF THE FIGURES

For a fuller understanding of the nature and objects of the disclosure, reference should be made to the following detailed description taken in conjunction with the accompanying drawings, in which:

FIG. 1 illustrates a system for providing a trained workplace culture assessment model, according to an embodiment;

FIG. 2A illustrates a method for providing a trained workplace culture assessment model, according to an embodiment;

FIG. 2B illustrates a method for providing a trained workplace culture assessment model, according to an embodiment;

FIG. 2C illustrates a method for providing a trained workplace culture assessment model, according to an embodiment;

FIG. 3 illustrates an example culture dimension definition, according to an embodiment;

FIG. 4 illustrates an example access refinement interface, according to an embodiment;

FIG. 5 illustrates an example workplace user experience assessment, according to an embodiment;

FIG. 6 illustrates an example presentation of workplace culture dimensions, according to an embodiment;

FIG. 7 illustrates an aggregated user assessment data visualization, according to an embodiment;

FIG. 8 illustrates an example recommendation provided by the system for developing the Talent dimension and the Organization dimension, according to an embodiment;

FIG. 9 illustrates an example selection of filter parameters, according to an embodiment;

FIG. 10 illustrates an example recommendation provided by the system for developing the Talent dimension and the Technology dimension, according to an embodiment;

FIG. 11 illustrates an example selection of filter parameters, according to an embodiment;

FIG. 12 illustrates an example recommendation provided by the system for developing the Leadership dimension and the Talent dimension based on the filters set in the example of FIG. 11, according to an embodiment;

FIG. 13 and FIG. 14 illustrate an example selection of filter parameters, according to an embodiment;

FIG. 15 illustrates an alternate dimension definition, according to an embodiment;

FIG. 16 illustrates a aggregated user assessment data visualization, according to an embodiment;

FIG. 17 illustrates an example presentation of workplace, according to an embodiment;

FIG. 18 illustrates an example scenario engine, according to an embodiment;

FIG. 19 and FIG. 20 illustrate an example summary report, according to an embodiment;

FIG. 21 illustrates an artificial neural network (ANN), according to an embodiment;

FIG. 22 illustrates a node, according to an embodiment;

FIG. 23 illustrates a method of training a machine learning model of a machine learning module, according to an embodiment;

FIG. 24 illustrates a method of analyzing input data using a machine learning module, according to an embodiment.

### DETAILED DESCRIPTION

It is to be understood that the invention is not limited in its application to the details of construction and the arrangements of components and/or method steps set forth in the following description or illustrated in the drawings, and phraseology and terminology used herein is for the purpose of description and should not be regarded as limiting. The invention is capable of other embodiments and of being practiced or being carried out in various ways. Accordingly, other aspects, advantages, and modifications will be apparent to those skilled in the art to which the invention pertains, and these aspects and modifications are within the scope of the invention, which is limited only by the appended claims.

Embodiments of the present disclosure may build the next cycle of culture to support workers across all realms—physical, virtual, and hybrid. Embodiments of the present disclosure may provide for a data driven perspective that cuts across all mechanisms of corporate support and culture, by positioning an organization's personnel in terms of their thoughts towards the organizational culture and provide recommendations on developing the organizational culture in a direction that is more remote-ready. Embodiments of the present disclosure may automate what is currently a very resource heavy, drawn out, prone to human interpretation strategic consulting model that may not be holistic to an organization or transparent to leadership.

The present disclosure may provide methods, systems, and apparatuses for training a remote workplace culture assessment model comprising a neural network. An assessment may be sent to a user device corresponding to a user of a workplace. The assessment may include a test statement. A user response to the test statement may be received. The user response and test statement may be applied to the remote workplace culture assessment model, thereby yielding a statement strength, a statement correlation, and a remote workplace culture profile. The weighting input of the remote workplace culture assessment model may be changed based on the statement strength and the statement correlation, thereby training the remote workplace culture assessment model.

The term “non-transitory”, as used herein, is a limitation of the medium itself (i.e., tangible, not a signal) as opposed to a limitation on data storage persistency (e.g., RAM vs. ROM).

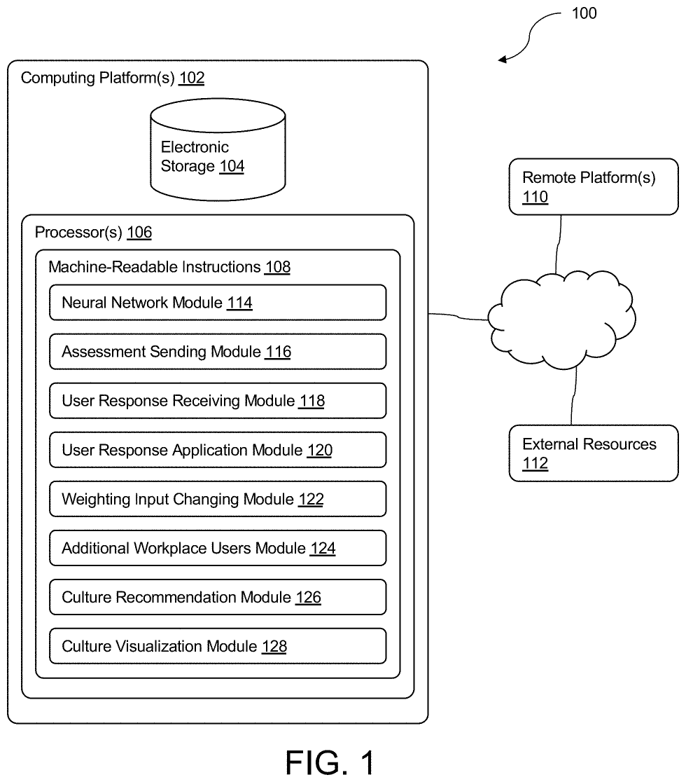

FIG. 1 illustrates a system 100 for providing a trained workplace culture assessment model, according to an embodiment. In some embodiments, system 100 may include one or more computing platforms 102. Computing platform(s) 102 may be configured to communicate with one or more remote platforms 110 according to a client/server architecture, a peer-to-peer architecture, and/or other architectures. Remote platform(s) 110 may be configured to communicate with other remote platforms via computing platform(s) 102 and/or according to a client/server architecture, a peer-to-peer architecture, and/or other architectures. Users may access system 100 via remote platform(s) 110. Computing platform(s) 102 may include a distributed computing architecture (e.g., one or more individual computing platforms operating in concert to accomplish a computing task).

In some embodiments, computing platform(s) 102, remote platform(s) 110, and/or external resources 112 may be operatively linked via one or more electronic communication links. For example, such electronic communication links may be established, at least in part, via a network such as the internet and/or other networks using, for example, TCP/IP or cellular hardware enabling wired or wireless (e.g., cellular, 2G, 3G, 4G, 4G LTE, 5G, or WiFi) communication. It will be appreciated that this is not intended to be limiting, and that the scope of this disclosure includes embodiments in which computing platform(s) 102, remote platform(s) 110, and/or external resources 112 may be operatively linked via some other communication media.

The internet may include an interconnected network of systems and a suite of protocols for the end-to-end transfer of data therebetween. A model describing may be the Transport Control Protocol and Internet Protocol (TCP/IP), which may also be referred to as the internet protocol suite. TCP/IP provides a model of four layers of abstraction: an application layer, a transport layer, an internet layer, and a link layer. The link layer may include hosts accessible without traversing a router, and thus may be determined by the configuration of the network (e.g., a hardware network implementation, a local area network, a virtual private network, or a networking tunnel). The link layer may be used to move packets of data between the internet layer interfaces of different hosts on the same link. The link layer may interface with hardware for end-to-end transmission of data. The internet layer may include the exchange of datagrams across network boundaries (e.g., from a source network to a destination network), which may be referred to as routing, and is performed using host addressing and identification over an internet protocol (IP) addressing system (e.g., IPv4, IPv6). A datagram may include a self-contained, independent, basic unit of data, including a header (e.g., including a source address, a destination address, and a type) and a payload (e.g., the data to be transported), to be transferred across a packet-switched network. The transport layer may utilize the user datagram protocol (UDP) to provide for basic data channels (e.g., via network ports) usable by applications for data exchange by establishing end-to-end, host-to-host connectivity independent of any underlying network or structure of user data. The application layer may include various user and support protocols used by applications users may use to create and exchange data, utilize services, or provide services over network connections established by the lower layers, including, for example, routing protocols, the hypertext transfer protocol (HTTP), the file transfer protocol (FTP), the simple mail transfer protocol (SMTP), and the dynamic host configuration protocol (DHCP). Such data creation and exchange in the application layer may utilize, for example, a client-server model or a peer-to-peer networking model. Data from the application layer may be encapsulated into UDP datagrams or TCP streams for interfacing with the transport layer, which may then effectuate data transfer via the lower layers.

A given remote platform 110 may include one or more processors configured to execute computer program modules. The computer program modules may be configured to enable an expert or user associated with the given remote platform 110 to interface with system 100 and/or external resources 112, and/or provide other functionality attributed herein to remote platform(s) 110. By way of non-limiting example, a given remote platform 110 and/or a given computing platform 102 may include one or more of a server, a desktop computer, a laptop computer, a handheld computer, a tablet computing platform, a Netbook, a Smartphone, a gaming console, and/or other computing platforms.

External resources 112 may include sources of information outside of system 100, external entities participating with system 100, and/or other resources. In some embodiments, some or all of the functionality attributed herein to external resources 112 may be provided by resources included in system 100.

Computing platform(s) 102 may include electronic storage 104, one or more processors 106, and/or other components. Computing platform(s) 102 may include communication lines, or ports to enable the exchange of information with a network and/or other computing platforms. Illustration of computing platform(s) 102 in FIG. 1 is not intended to be limiting. Computing platform(s) 102 may include a plurality of hardware, software, and/or firmware components operating together to provide the functionality attributed herein to computing platform(s) 102. For example, computing platform(s) 102 may be implemented by a cloud of computing platforms operating together as computing platform(s) 102.

Electronic storage 104 may comprise non-transitory storage media that electronically stores information. The electronic storage media of electronic storage 104 may include one or both of system storage that is provided integrally (i.e., substantially non-removable) with computing platform(s) 102 and/or removable storage that is removably connectable to computing platform(s) 102 via, for example, a port (e.g., a USB port, an IEEE 1394 port, a THUNDERBOLT™ port, etc.) or a drive (e.g., disk drive, flash drive, or solid-state drive etc.). Electronic storage 104 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 104 may include one or more virtual storage resources (e.g., cloud storage, a virtual private network, and/or other virtual storage resources). Electronic storage 104 may store software algorithms, information determined by processor(s) 106, information received from computing platform(s) 102, information received from remote platform(s) 110, databases (e.g., MYSQL®, MARIADB®, MONGODB®, and the like) and/or other information that enables computing platform(s) 102 to function as described herein.

Processor(s) 106 may be configured to provide information processing capabilities in computing platform(s) 102. As such, processor(s) 106 may include one or more of a digital processor, an analog processor, a digital circuit designed to process information, an analog circuit designed to process information, a state machine, and/or other mechanisms for electronically processing information. Although processor(s) 106 is shown in FIG. 1 as a single entity, this is for illustrative purposes only. In some embodiments, processor(s) 106 may include a plurality of processing units. These processing units may be physically located within the same device, or processor(s) 106 may represent processing functionality of a plurality of devices operating in coordination. Processor(s) 106 may be configured to execute one or more of the modules disclosed herein, and/or other modules. Processor(s) 106 may be configured to execute one or more of the modules disclosed herein, and/or other modules by software; hardware; firmware; some combination of software, hardware, and/or firmware; and/or other mechanisms for configuring processing capabilities on processor(s) 106. As used herein, the term “module” may refer to any component or set of components that perform the functionality attributed to the module. This may include one or more physical processors during execution of processor readable instructions, the processor readable instructions, circuitry, hardware, storage media, or any other components. Various modules or portions thereof may be implemented in any of various ways, including procedure-based techniques, component-based techniques, and/or object-oriented techniques, among others. For example, the program instructions may be implemented using system libraries, language libraries, model-view-controller (MVC) principles, application programming interfaces (APIs), system-specific programming languages and principles, cross-platform programming languages and principles, pre-compiled programming languages, markup programming languages, stylesheet languages, “bytecode” programming languages, object-oriented programming principles or languages, other programming principles or languages, C, C++, C#, Java, JavaScript, Python, PHP, HTML, CSS, TypeScript, R, Elm, Unity, VB.Net, Visual Basic, Swift, Objective-C, Perl, Ruby, Go, SQL, Haskell, Scala, Arduino, assembly language, Microsoft Foundation Classes (MFC), Streaming SIMD Extension (SSE), or other technologies or methodologies, as desired.

It should be appreciated that although the modules disclosed herein are illustrated in FIG. 1 as being implemented within a single processing unit, in embodiments in which processor(s) 106 includes multiple processing units, one or more of modules disclosed herein may be implemented remotely from the other modules. The description of the functionality provided by the different modules disclosed herein is for illustrative purposes, and is not intended to be limiting, as any of modules described herein may provide more or less functionality than is described. For example, one or more of modules disclosed herein may be eliminated, and some or all of its functionality may be provided by other ones of modules disclosed herein. As another example, processor(s) 106 may be configured to execute one or more additional modules that may perform some or all of the functionality attributed herein to one of modules disclosed herein.

Computing platform(s) 102 may be configured by machine-readable instructions 108. Machine-readable instructions 108 may include one or more instruction modules. The instruction modules may include computer program modules. The instruction modules may include one or more of the modules disclosed herein and/or other instruction modules.

A neural network module 114 may include one or more instruction modules configured to instruct the processor to provide the remote workplace culture assessment model comprising a neural network comprising a logical connection connecting a user response input, a test statement input, a weighting input, a statement strength output, a statement correlation output, and a remote workplace culture profile output. The neural network may be configured to be trained by changing the weighting input. The remote workplace culture profile output may include one or more culture dimensions. The culture dimensions may include leadership, organization, workforce (or talent), and technology.

An assessment sending module 116 may include one or more instruction modules configured to instruct the processor to send an assessment to a user device corresponding to a user of a workplace, the assessment including a test statement.

A user response receiving module 118 may include one or more instruction modules configured to instruct the processor to receive, from the user device, a user response to the test statement.

A user response application module 120 may include one or more instruction modules configured to instruct the processor to apply the user response to the user response input of the remote workplace culture assessment model and the test statement to the test statement input of the remote workplace culture assessment model, thereby yielding a statement strength at the statement strength output, a statement correlation at the statement correlation output, and a remote workplace culture profile at the remote workplace culture profile output.

A weighting input changing module 122 may include one or more instruction modules configured to instruct the processor to change the weighting input of the remote workplace culture assessment model based on the statement strength and the statement correlation, thereby training the remote workplace culture assessment model.

An additional workplace users module 124 may include one or more instruction modules configured to instruct the processor to, with one or more additional user devices, each additional user device corresponding to an additional user, send an additional assessment to each additional user device, the additional assessment including an additional test statement, receive, from each of the one or more additional user devices, an additional user response to the additional test statement, apply each additional user response to the user response input of the remote workplace culture assessment model and each additional test statement to the test statement input of the remote workplace culture assessment model, thereby yielding one or more additional statement strengths at the statement strength output, one or more additional statement correlations at the statement correlation output, and one or more additional remote workplace culture profiles at the remote workplace culture profile output, and change the weighting input of the remote workplace culture assessment model based on the one or more additional statement strengths and the one or more additional statement correlations, thereby training the remote workplace culture assessment model.

A culture recommendation module 126 may include one or more instruction modules configured to instruct the processor to provide a recommendation to improve the workplace for remote work. The recommendation may be associated with one or more culture dimensions.

A culture visualization module 128 may include one or more instruction modules configured to instruct the processor to compose a cumulative culture profile visualization based on the cumulative culture profile of the workplace.

Various steps, functions, and/or operations of computing platform(s) 102, remote platform(s) 110, and/or external resources 112 and the methods disclosed herein may be carried out by one or more of, for example, electronic circuits, logic gates, multiplexers, programmable logic devices, ASICs, analog or digital controls/switches, microcontrollers, or computing systems. Program instructions implementing methods such as those described herein may be transmitted over or stored on carrier medium. The carrier medium may include a storage medium such as a read-only memory, a random-access memory, a magnetic or optical disk, a non-volatile memory, a solid-state memory, a magnetic tape, and the like. A carrier medium may include a transmission medium such as a wire, cable, or wireless transmission link. For instance, the various steps described throughout the present disclosure may be carried out by a single processor 106 (or computing platform 102) or, alternatively, multiple processors 106 (or multiple computing platforms 102). Moreover, different sub-systems of system 100 may include one or more computing or logic systems. Therefore, the description herein should not be interpreted as a limitation on the present disclosure but merely an illustration.

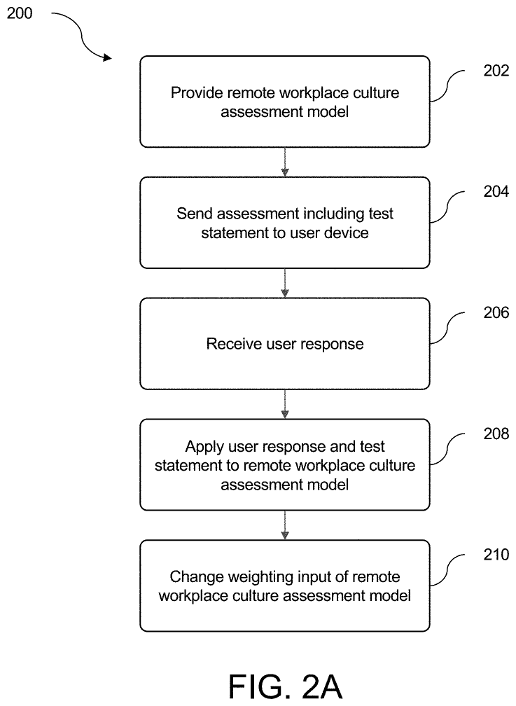

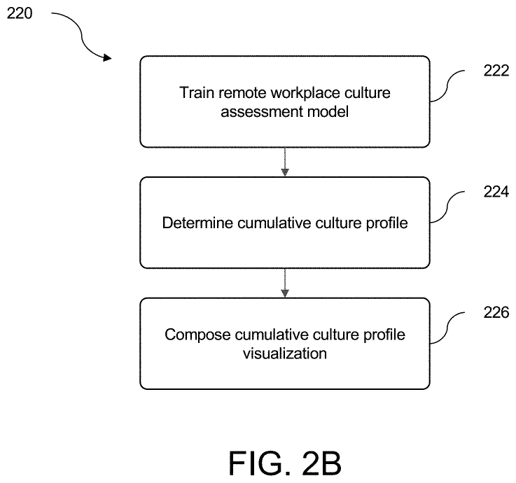

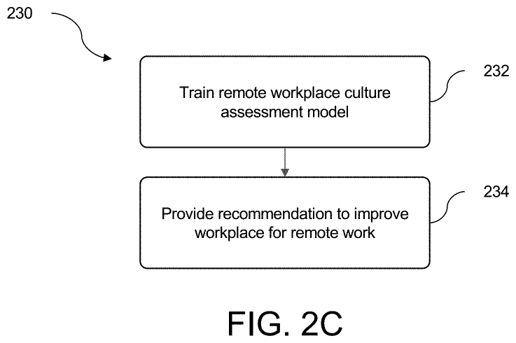

FIG. 2A illustrates a method 200 for providing a trained workplace culture assessment model, according to an embodiment. The operations of method 200 presented herein are intended to be illustrative. In some embodiments, method 200 may be accomplished with one or more additional operations not described, and/or without one or more of the operations discussed. Additionally, the order in which the operations of method 200 are illustrated in FIG. 2A and described herein is not intended to be limiting.

An operation 202 may include providing the remote workplace culture assessment model comprising a neural network comprising a logical connection connecting a user response input, a test statement input, a weighting input, a statement strength output, a statement correlation output, and a remote workplace culture profile output. The neural network may be trained by changing the weighting input. The remote workplace culture profile output may include one or more culture dimensions. The culture dimensions may include leadership, organization, workforce (or talent), and technology. Operation 202 may be performed by one or more hardware processors configured by machine-readable instructions including a module in accordance with one or more embodiments.

An operation 204 may include sending an assessment to a user device corresponding to a user of a workplace. The assessment may include a test statement. Operation 204 may be performed by one or more hardware processors configured by machine-readable instructions including a module in accordance with one or more embodiments.

An operation 206 may include receiving, from the user device, a user response to the test statement. Operation 206 may be performed by one or more hardware processors configured by machine-readable instructions including a module in accordance with one or more embodiments.

An operation 208 may include applying the user response to the user response input of the remote workplace culture assessment model and the test statement to the test statement input of the remote workplace culture assessment model, thereby yielding a statement strength at the statement strength output, a statement correlation at the statement correlation output, and a remote workplace culture profile at the remote workplace culture profile output. Operation 208 may be performed by one or more hardware processors configured by machine-readable instructions including a module in accordance with one or more embodiments.

An operation 210 may include changing the weighting input of the remote workplace culture assessment model based on the statement strength and the statement correlation, thereby training the remote workplace culture assessment model. Operation 210 may be performed by one or more hardware processors configured by machine-readable instructions including a module in accordance with one or more embodiments.

One or more of operations 202, 204, 206, 208, and 210 may be repeated for one or more additional user devices associated with one or more additional users of the workplace.

FIG. 2B illustrates a method 220 for providing a trained workplace culture assessment model, according to an embodiment. The operations of method 220 presented herein are intended to be illustrative. In some embodiments, method 220 may be accomplished with one or more additional operations not described, and/or without one or more of the operations discussed. Additionally, the order in which the operations of method 220 are illustrated in FIG. 2B and described herein is not intended to be limiting.

An operation 222 may include training a remote workplace culture assessment model. Operation 222 may be performed by one or more hardware processors configured by machine-readable instructions including a module in accordance with one or more embodiments.

An operation 224 may include determining a cumulative culture profile of a workplace. Operation 224 may be performed by one or more hardware processors configured by machine-readable instructions including a module in accordance with one or more embodiments.

An operation 226 may include composing a visualization for the cumulative culture profile of the workplace. Operation 226 may be performed by one or more hardware processors configured by machine-readable instructions including a module in accordance with one or more embodiments.

FIG. 2C illustrates a method 230 for providing a trained workplace culture assessment model, according to an embodiment. The operations of method 230 presented herein are intended to be illustrative. In some embodiments, method 230 may be accomplished with one or more additional operations not described, and/or without one or more of the operations discussed. Additionally, the order in which the operations of method 230 are illustrated in FIG. 2C and described herein is not intended to be limiting.

An operation 232 may include training a remote workplace culture assessment model. Operation 232 may be performed by one or more hardware processors configured by machine-readable instructions including a module in accordance with one or more embodiments.

An operation 234 may include providing a recommendation to improve a workplace for remote work, for example, based on a cultural dimension. Operation 234 may be performed by one or more hardware processors configured by machine-readable instructions including a module in accordance with one or more embodiments.

In some embodiments, method 200, 220, or 230 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200, 220, or 230 in response to instructions stored electronically on an electronic storage medium. The one or more processing devices may include one or more devices configured through hardware, firmware, and/or software to be specifically designed for execution of one or more of the operations of method 200, 220, or 230.

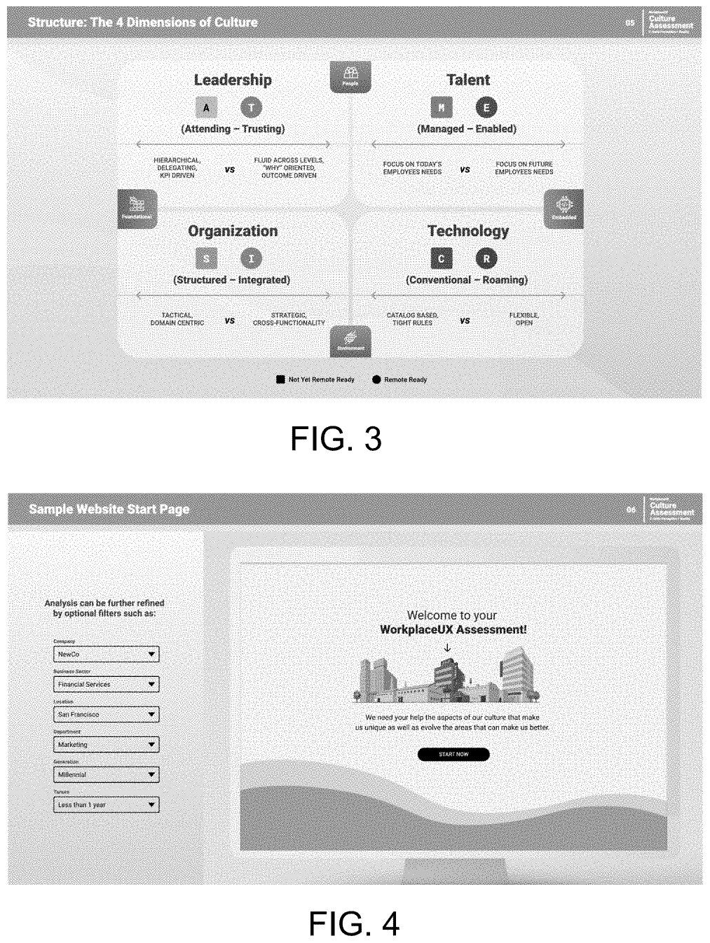

FIG. 3 illustrates an example culture dimension definition, according to an embodiment. With reference to FIG. 3, in embodiments, a system may consider there to be four dimensions or “quadrants” of culture in an organization such as a workplace. The four dimensions may include “Leadership,” “Talent,” “Organization,” and “Technology.” The Talent dimension may be referred to in some embodiments as “Workforce.” The system may assess the user's views of the organization in each of the four dimensions to determine the user's culture profile for the organization (where “user” may be used herein to refer to an employee or other personnel of the organization). For the Leadership dimension, the system may assess that a user tends towards finding the organization either “Attending” (e.g., hierarchical, delegating, KPI driven) or “Trusting” (e.g., fluid across levels, “why”-oriented, outcome driven), where a Trusting organization may be more ready for remote work than an Attending organization. For example, an organization may prefer to have people in the office for assignments and completions of tasks (tending towards Attending) or may trust that people will get things done on time and delivered (tending towards Trusting). For the “Organization” dimension, the system may assess that the user tends towards finding the organization “Structured” (e.g., tactical, domain centric) or “Integrated” (e.g., strategic, cross-functionality), where an Integrated organization may be more ready for remote work than a Structured organization. For example, a tactical, domain-structured approach in an organization, where employees work in a departmental fashion and may not cross over between departments to achieve objectives, may be more structured and less ready for remote work than an Integrated organization, where employees work between departments to achieve objectives. For the Talent dimension, the system may assess that the user finds the organization to tend towards being “Managed” (e.g., focusing on today's employees' needs) or “Enabled” (e.g., focusing on future employees' needs), where an Enabled organization may be more ready for remote work than a Managed organization. For example, an expectation of being told what to do, consistent and frequent meetings, etc., may be indicative of a Managed organization culture. For the “Technology” dimension, a user may find the organization to tend towards being “Conventional” (e.g., catalog-based, tight rules) or “Roaming” (e.g., flexible, open), where a Roaming organization may be more ready for remote work than a Conventional organization. For example, in the Technology dimension, the technology of a Roaming organization may allow users (e.g., workers) to be at or near the same level of productivity no matter where they are—whether in the office (e.g., a physical realm), at home, on a plane, in a hotel, in a coffee shop, etc.

As another example, a Roaming organization may provide a “sandbox” (e.g., a controlled virtual environment separated from other applications) for a user to install and try out computer applications, whereas in contrast, a Conventional organization may have policies or other rules in place (e.g., as implemented by an information security department) that restrict access to a sandbox for security reasons. In such an example, the information security department of a Conventional organization may restrict access in the name of security, without trying to understand how to facilitate a request for access for business and/or innovation reasons. Such an example may be particularly likely to take place in an organization where the Leadership and/or Organization dimensions are not adequately developed, whereas in an organization where such dimensions are developed, and the reasons for access to a sandbox may therefore be understood and supported, the information security department may be positioned (or, e.g., directed) to understand what it may take to improve security measures that would allow the sandbox to safely and/or securely be used.

Furthermore, in some examples where the Technology dimension is not adequately developed, a sandbox might be available, but the organization may only let users access it when they are in the office (e.g., in the physical realm of the organization), or may only allow users to access it with extra steps or other layers of security that diminish useability.

As noted above, an organization that tends towards being Attending, Managed, Structured, or Conventional (shown as squares in FIG. 3) may be less remote-ready than an organization that tends towards being Trusting, Enabled, Integrated, or Roaming (shown as circles in FIG. 3). Furthermore, each of these dimensions may be on a scale between the two extremes, and the further to the right in each of the dimensions (e.g. towards Trusting, Enabled, Integrated, or Roaming), the more remote-ready an organization may be, including in relation to productivity. Based on the two preferences for each of the four individual dimensions, there may be sixteen different culture profiles. However, embodiments are not limited thereto.

In embodiments, with reference to FIG. 3, the system may consider the Leadership and Organization dimensions to be a pair of foundational dimensions, meaning that these two dimensions may be the most important of the four dimensions to first develop in order to develop the other dimensions and/or poise the organization for remote work. In some embodiments, the other dimensions—for example, Technology—when taken alone, may not be able to change how an organization operates. Thus, the Leadership and Organization dimensions may be foundational in that when they are both developed to be remote ready, they may be able to change the other dimensions (described herein as Technology and Talent, but not limited thereto) by, e.g., instituting new policies, leading better investments (e.g., in technology and/or people) and influence a culture that evolves the business. As discussed below, in a rules-based hierarchy of culture profiles, the system according to embodiments may always prefer culture profiles that are remote ready in both the Leadership and Organization dimensions and may provide recommendations directed thereto.

Likewise, the system may consider the Leadership and Talent dimensions to both deal with people, the Organization and Technology dimensions to both deal with the environment for supporting the people, and the Talent and Technology dimensions to both be embedded—for example, embedded in the sense that they are resistant to change without first having developed the Leadership and Organization dimensions.

FIG. 4 illustrates an example access refinement interface, according to an embodiment. A user may access an assessment provided by the system through any of a number of methods. For example, the user may access the assessment through a web-based interface or a computer application. In some embodiments, the assessment may be provided in a way such that the user's response is anonymous. However, regardless of anonymity and as shown by example in the drop-down menus of FIG. 4, certain information about the user may be collected by the assessment, such as the name of their employer, their business sector, their office location, their department, their generation (e.g., Gen X or Millennial), and their tenure at their employer. Additionally, in the drop-down menus, the system may ask for the user's residential zip code. As discussed herein, these “layers” of user information may provide for the system to target how to best develop the organization.

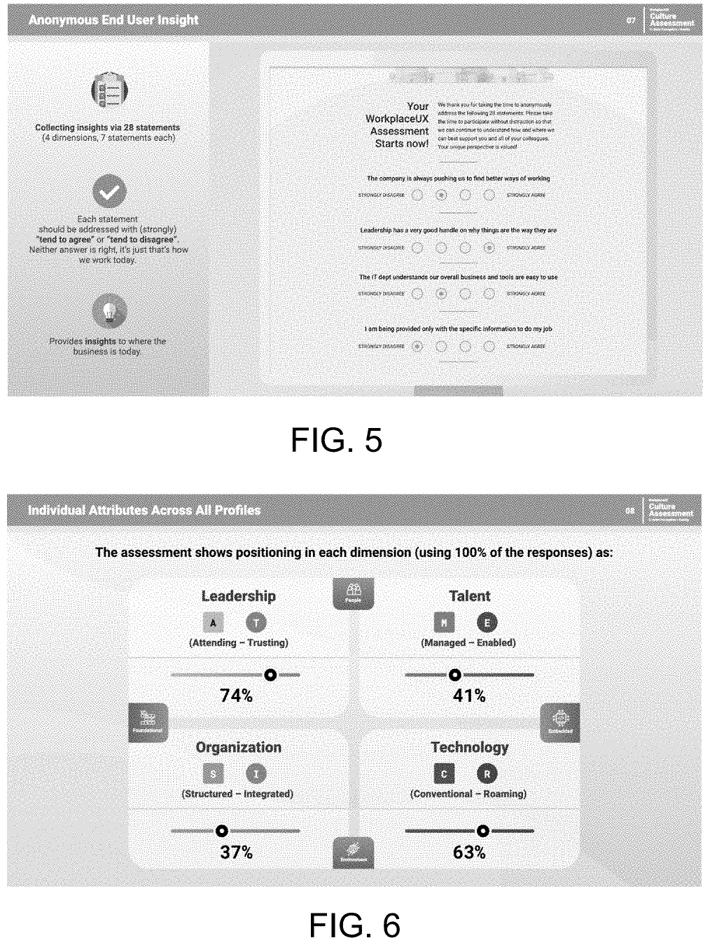

FIG. 5 illustrates an example workplace user experience assessment, according to an embodiment. In embodiments, and as shown by example in FIG. 5, the assessment may present the user with a series of statements to which the user may respond. In an example, the user may respond with an indication as to whether they agree or disagree with the statement. For example, as illustrated in FIG. 5, the user may be able to select whether they strongly agree, tend to agree, tend to disagree, or strongly disagree with a given statement. In some embodiments, each statement may relate to one of the four dimensions, but embodiments are not limited thereto, and in other embodiments, a statement may relate to more than one of the four dimensions. Further, embodiments are not limited to statements, and in some embodiments, the assessment may include questions, other text, pictures, and/or any other manner of conveying information.

In an example embodiment, the assessment may include twenty-eight statements, with seven statements for each of the four dimensions. This number of statements may provide for an acceptably-accurate assessment without being a significant burden on a user's time. However, embodiments are not limited thereto.

In some embodiments, the system will continue to improve upon the statements, for example, as it determines which statements lead to more accurate assessments. In some embodiments, each of the statements may be categorized by the system so that when data comes back from the user assessments, if a dimension gets a low score, the system may inform the client about the specific area in which the organization is receiving a low score. For example, users may be indicating (e.g., from responses to assessment statements) that they don't have the technology to work from home, that reviews are not productive, etc. Such issues may be pinpointed by the system.

Furthermore, the system may include test statements in the user assessment in order to determine whether and how such test statements correlate to each of the four dimensions. Should a particular statement be determined to correlate well with one or more of the dimensions, the system may include the statement in future assessments. Additionally, in some embodiments, the system may determine, through crowdsourcing, artificial intelligence and machine learning (AI/ML), etc., the best statements for a given dimension for a specified type of business.

Also, in some embodiments, the system may learn the correspondence of each statement to each of the dimensions and weigh a user's responses to the statement accordingly. For example, for a statement that the system learns has only a 0.5 correlation to the Leadership dimension, the system may weigh the user's response to that statement only 0.5 times as much as a statement that correlates fully to Leadership. Additionally, the system may weigh one or more of the dimensions of a user's culture profile according to that user's role in the company, and the degree to which those dimensions are relevant to the user's role. [0021] In embodiments, for filtered user profiles (described herein) or for all of the user profiles collected for an organization (such as a workplace), the system may visualize the cumulative associated data in different ways.

FIG. 6 illustrates an example presentation of workplace culture dimensions, according to an embodiment. For example, in some embodiments and with reference to FIG. 6, each of the four individual dimensions may be presented as a positioning of the cumulative user profiles in each dimension. In some embodiments, this cumulative positioning may be based on averages of all user culture profiles (or, e.g., all user culture profiles for a selected segment of the organization, filtered as described herein). As shown in the example of FIG. 6, a cumulative user profile of each of the four dimensions of Leadership, Talent, Organization, and Technology is displayed as a singular culture profile for the organization. In the illustrated example, the organization (as a whole or as filtered) has a Trusting-Managed-Structured-Roaming culture profile. Together with this visualization, the system may be able to make observations for the client. For example, the system may note that Technology is only at 63% Roaming, but that this may be because Talent is only at 41% —in other words, the users are not being adequately enabled, so they lack clarity on what technology to use, how to use it, what training is available, etc. Other observations may be made by the system based on its understanding (which may be learned, e.g., through AI/ML) of the correlations between each dimension.

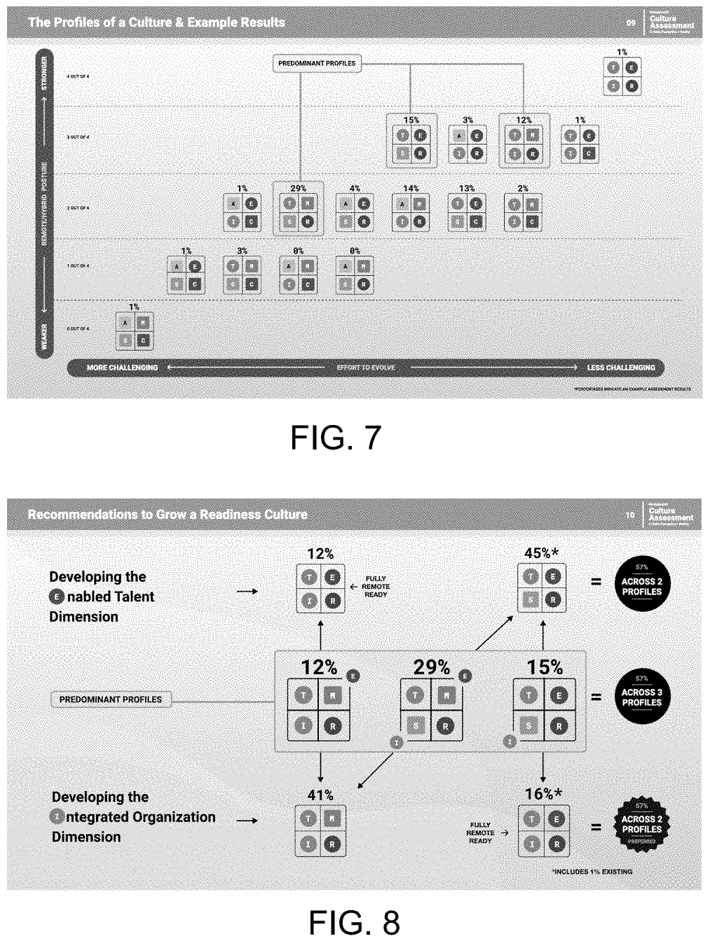

FIG. 7 illustrates an aggregated user assessment data visualization, according to an embodiment. As another example of visualization provided by the system according to embodiments, FIG. 7 illustrates the amount of each of the sixteen possible culture profiles received from the user assessments. In embodiments, the culture profiles shown in FIG. 7 may be weighted in two ways. First, the profiles may be weighted by the number of “round” or “remote ready” dimensions out of the total of four dimensions. There may be five levels to this weighting (0-4, 1-4, 2-4, 3-4, 4-4), where a fully remote ready profile is 4-4 and a least remote ready profile is 0-4. For example, at the top right, the system illustrates that the fully remote ready profile of Trusting-Integrated-Enabled-Roaming makes up 1% of the culture profiles assessed by the users. The second modality of weighting the sixteen total combinations may be in an order that designates how much effort and investment there may be to evolve each profile to a fully remote ready profile (4-4). For example, when weighing these profiles, it may be important for the system to weigh them by both the weighted combination (e.g., 0-4, 1-4, 2-4, 3-4, 4-4, making up the different vertical “levels”), as well as weighing the combinations on the same level (e.g., 2-4) according to their varying degrees of difficulty associated with improving. For example, with reference to level 2-4, the culture profiles with both the “foundational” dimensions (Leadership and Organization) indicated as remote-ready may be visualized towards the right, as these profiles may be less challenging to improve than those that do not have the “foundational” dimensions developed. Also, the pairing of certain dimensions (foundational, embedded, people, environment) may be considered by the system when making recommendations, as discussed herein.

FIG. 8 illustrates an example recommendation provided by the system for developing the Talent dimension and the Organization dimension, according to an embodiment. In this example, the system has identified three predominant culture profiles of the organization as shown in FIG. 7, and suggested recommendations. For example, the system illustrates that developing the Talent dimension will collapse the three predominant culture profiles into two profiles, and that developing the Organization dimension will also collapse the three predominant culture profiles into two profiles. As illustrated in the example, developing the Talent dimension may lead to a workforce that is 57% remote-ready according to at least three dimensions, and 12% that is fully remote ready, whereas developing the Organization dimension may lead to a workforce that is 57% remote-ready according to at least three dimensions, and 16% that is fully remote ready. Further, developing the Organization dimension may lead to the “foundational” dimension pair (Leadership and Organization) being developed for 57% of the profiles. Therefore, the system according to this example may recommend that developing the Organization dimension is preferred.

As described herein, there are four dimensions, but embodiments are not limited thereto. In some embodiments, in making a recommendation, the system may also factor in additional information such as the cost of changing the respective dimensions, the number of users that will be impacted, etc.

In embodiments, after the system has collected user culture profiles, the client (e.g., HR, CEO, or other leader of the organization) may be able to select filters that specify a desired data set—for example, the client may want to understand a certain segment of the workforce's perspective on current culture. Such filters may be based on the user information collected with reference to FIG. 4, but embodiments are not limited thereto, and additional filters may be provided to the client, such as those based on metrics related to the user. For example, the client may wish to filter based on those users that use new technology provided by the company. In some embodiments, the system may determine that certain filters result in a significant difference in the filtered culture profiles, and suggest filtering based on such filters. For example, the system may determine that users with an office location in San Francisco tend to be more Roaming rather than Conventional, whereas users in another office location are more Conventional, and suggest this as a filter for the client to consider.

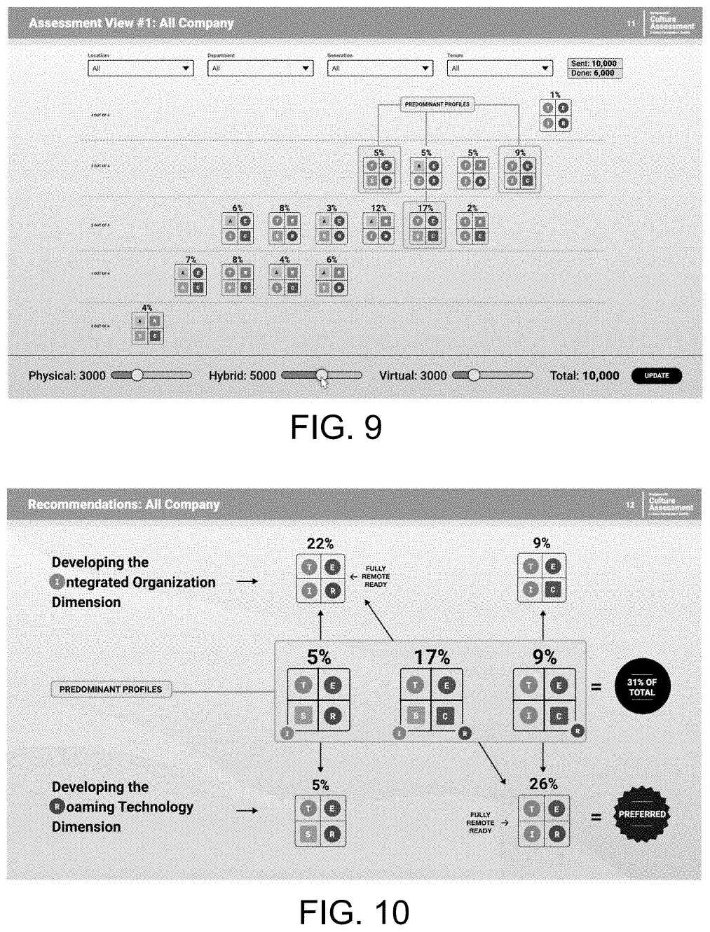

FIG. 9 illustrates an example selection of filter parameters, according to an embodiment. In an example, with reference to FIG. 9, a user may set the filters at the top of a user interface presented by the system (e.g., through a display device), and click, touch, or otherwise select the “update” button on the bottom right. In the example shown by FIG. 9, the filters are each set to “ALL” to view the entire organization. The system indicates that 10,000 links to assessments have been sent to the users, and that the system has received 6,000 completed assessments. The system may refer to the collected user data, and the distribution of culture profiles across the specified data set may be displayed. Additionally, “sliders” may be displayed (e.g., at the bottom), which may refence the culture profile data and the cumulative of individual dimensions in determining default physical, hybrid, and virtual personnel numbers. The rules-based hierarchy of the system described herein may drive recommendations in two ways. First, there may be default recommendations for groups and quantities of workers that should be considered for each realm of work—physical, hybrid, and fully virtual. For example, in the illustration shown, the system may use an algorithm to determine and indicate that 3,000 users should be physical, 5,000 should be hybrid, and 3,000 should be virtual. Second, the engine may offer specific actions to strengthen the culture of support and productivity across all three realms appropriately. Additionally, in some embodiments, the system may match a user's zip code against the zip code of the office in which they indicate that they work, then approximate the commute from publicly available sources and/or data. Based on generally accepted commute times and the culture profile suitability, the system may include default or customized recommendations that show the improvements needed to support users in the right realm, and/or which departments, groups, roles, etc. should be virtual, hybrid, physical (and which should not). Further, according to some embodiments, the system (e.g., an algorithm of the system) may be able to reference commute times, compare such times to either a default or customized (e.g., by a client) weighting of departments, teams, roles, etc., that may be classified as acceptable for remote and/or hybrid work (e.g., sales may be deemed acceptable for remote and/or hybrid work whereas a manager of floor production may not), and then inform a client (e.g., via a user interface) how the organization's culture profiles illustrate the organization's current positioning for remote work. Further, the system may provide recommendations on how to position the users (e.g., based on the culture profiles) to be more productive, and therefore, more likely to want to stay.

Thus, in embodiments, the system may provide the default numbers across the physical, hybrid, and virtual realms in accordance with the above and as described herein, and furthermore, the system may provide a client with the option to adjust the numbers (e.g., in any of the physical, hybrid, and virtual realms) and thereafter illustrate how roles, commuting, and culture profiles impact remote readiness of the organization, and specific improvements that may be needed by the organization to better support productivity.

For example, in embodiments, as shown in FIG. 9, after digesting the recommendations, the client may have the ability to adjust the sliders for a desired quantity of workers within each realm—physical, hybrid, fully virtual. For example, the system may provide for the client to adjust the default number of physical users. When the “UPDATE” button is selected after the manual changes via the sliders, the system may adjust the recommendations on how to better support these workers accordingly and may provide a visualization of how varying the default impacts the analysis. The recommendations may be generated by the system engine based on the assessment data and the rules-based hierarchy of the culture profiles. By manually changing the default recommendations of physical, virtual or hybrid workers provided by the system, the client may increase/decrease the number of culture profiles that apply to each realm. The algorithm of the system may then reconsider the new options by referencing the filters set by the client (as discussed herein) as well as the weighting of the rules-based hierarchy of the culture profiles to inform the client of the development that may need to be accomplished to create a “remote ready” organization. The new recommendations may then be automatically generated by the system for the new settings as set by the client. In this way, the client may be able to experiment with settings to have the system evaluate the results and recommendations of having different departments, teams, roles, locations, etc., in different realms.

FIG. 10 illustrates an example recommendation provided by the system for developing the Talent dimension and the Technology dimension, according to an embodiment. In this example, the system has identified three predominant culture profiles of the organization as shown in FIG. 9 and provided a recommendation to develop the Technology dimension.

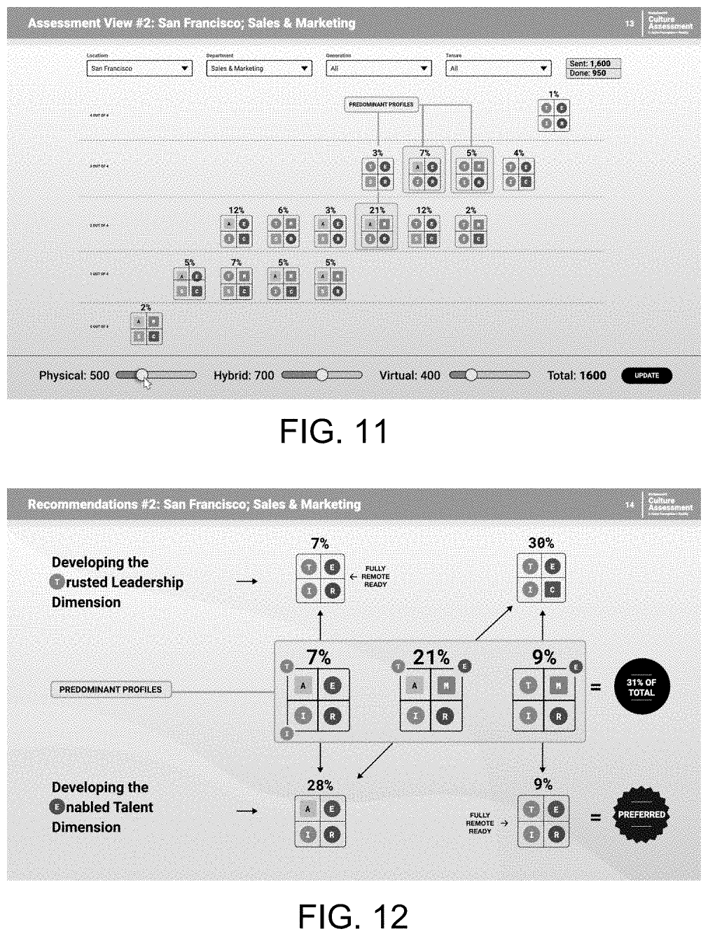

FIG. 11 illustrates an example selection of filter parameters, according to an embodiment. In an example shown in FIG. 11, the client has further set the filters at the top of the user interface of the system. Here, the client has selected San Francisco for location, and Sales & Marketing for department. Then, the user selected the “UPDATE” button on the bottom right, the system engine referred to the collected user data, and the distribution of culture profiles across the specified data set is displayed.

FIG. 12 illustrates an example recommendation provided by the system for developing the Leadership dimension and the Talent dimension based on the filters set in the example of FIG. 11, according to an embodiment. In this example, like in FIG. 8, the system has identified the three predominant culture profiles of the organization for the selected filters, and concluded that developing the Talent dimension may lead to a workforce that is 37% remote-ready according to at least three dimensions, and 9% that is fully remote ready, making it the preferred dimension to develop.

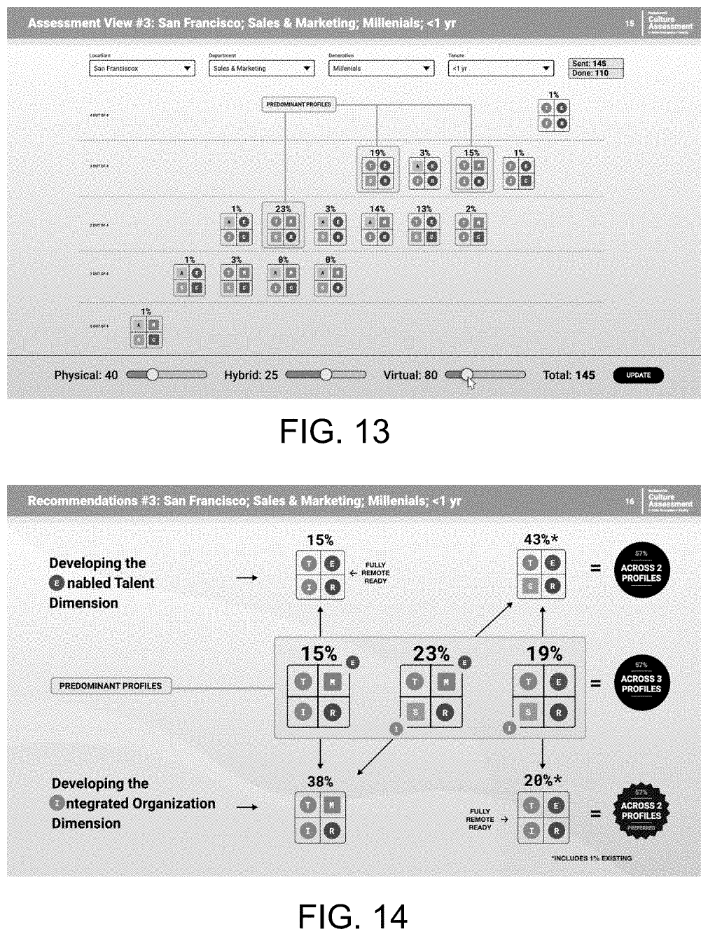

FIG. 13 and FIG. 14 illustrate an example selection of filter parameters, according to an embodiment. FIGS. 13 and 14 illustrate another example according to some embodiments, where a client may further set the filters—here, San Francisco as location, Sales & Marketing as Department, Millennials as generation, and <1 year as tenure—and receive recommendations for the three resulting predominant profiles, similar to as discussed elsewhere herein.

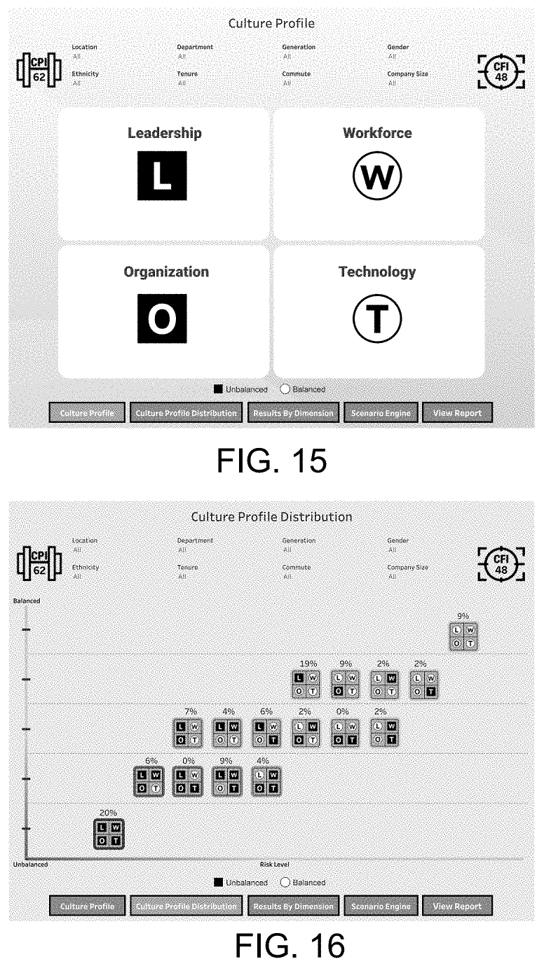

FIG. 15 illustrates an alternate dimension definition, according to an embodiment. The alternate dimension definition of FIG. 15 may provide for a simplified interface for users and administrators alike, as each of the four culture definitions may begin with a different letter. With reference to FIG. 15, in embodiments, a system may consider there to be four dimensions or “quadrants” of culture in an organization such as a workplace. The four dimensions may include “Leadership,” “Workforce,” “Organization,” and “Technology.” The system may assess the user's views of the organization in each of the four dimensions to determine the user's culture profile for the organization (where “user” may be used herein to refer to an employee or other personnel of the organization). For the Leadership dimension, the system may assess that a user tends towards finding the organization either “Attending” (e.g., hierarchical, delegating, KPI driven) or “Trusting” (e.g., fluid across levels, “why”-oriented, outcome driven), where a Trusting organization may be more ready for remote work than an Attending organization. For example, an organization may prefer to have people in the office for assignments and completions of tasks (tending towards Attending) or may trust that people will get things done on time and delivered (tending towards Trusting). For the “Organization” dimension, the system may assess that the user tends towards finding the organization “Structured” (e.g., tactical, domain centric) or “Integrated” (e.g., strategic, cross-functionality), where an Integrated organization may be more ready for remote work than a Structured organization. For example, a tactical, domain-structured approach in an organization, where employees work in a departmental fashion and may not cross over between departments to achieve objectives, may be more structured and less ready for remote work than an Integrated organization, where employees work between departments to achieve objectives. For the Workforce dimension, the system may assess that the user finds the organization to tend towards being “Managed” (e.g., focusing on today's employees' needs) or “Enabled” (e.g., focusing on future employees' needs), where an Enabled organization may be more ready for remote work than a Managed organization. For example, an expectation of being told what to do, consistent and frequent meetings, etc., may be indicative of a Managed organization culture. For the “Technology” dimension, a user may find the organization to tend towards being “Conventional” (e.g., catalog-based, tight rules) or “Roaming” (e.g., flexible, open), where a Roaming organization may be more ready for remote work than a Conventional organization. For example, in the Technology dimension, the technology of a Roaming organization may allow users (e.g., workers) to be at or near the same level of productivity no matter where they are—whether in the office (e.g., a physical realm), at home, on a plane, in a hotel, in a coffee shop, etc.

As noted above, an organization that tends towards being Attending, Managed, Structured, or Conventional (shown as squares in FIG. 15) may be less remote-ready than an organization that tends towards being Trusting, Enabled, Integrated, or Roaming (shown as circles in FIG. 15). Furthermore, each of these dimensions may be on a scale between the two extremes, and the further to the right in each of the dimensions (e.g. towards Trusting, Enabled, Integrated, or Roaming), the more remote-ready an organization may be, including in relation to productivity. Based on the two preferences for each of the four individual dimensions, there may be sixteen different culture profiles. However, embodiments are not limited thereto.

In embodiments, with reference to FIG. 15, the system may consider the Leadership and Organization dimensions to be a pair of foundational dimensions, meaning that these two dimensions may be the most important of the four dimensions to first develop in order to develop the other dimensions and/or poise the organization for remote work. In some embodiments, the other dimensions—for example, Technology—when taken alone, may not be able to change how an organization operates. Thus, the Leadership and Organization dimensions may be foundational in that when they are both developed to be remote ready, they may be able to change the other dimensions (described herein as Technology and Workforce, but not limited thereto) by, e.g., instituting new policies, leading better investments (e.g., in technology and/or people) and influence a culture that evolves the business. As discussed below, in a rules-based hierarchy of culture profiles, the system according to embodiments may always prefer culture profiles that are remote ready in both the Leadership and Organization dimensions and may provide recommendations directed thereto.

Likewise, the system may consider the Leadership and Workforce dimensions to both deal with people, the Organization and Technology dimensions to both deal with the environment for supporting the people, and the Workforce and Technology dimensions to both be embedded— for example, embedded in the sense that they are resistant to change without first having developed the Leadership and Organization dimensions.

FIG. 16 illustrates an aggregated user assessment data visualization, according to an embodiment. As another example of visualization provided by the system according to embodiments, FIG. 16 illustrates the amount of each of the sixteen possible culture profiles received from the user assessments. In embodiments, the culture profiles shown in FIG. 16 may be weighted in two ways. First, the profiles may be weighted by the number of “round” or “remote ready” dimensions out of the total of four dimensions. There may be five levels to this weighting (0-4, 1-4, 2-4, 3-4, 4-4), where a fully remote ready profile is 4-4 and a least remote ready profile is 0-4. For example, at the top right, the system illustrates that the fully remote ready profile of Trusting-Integrated-Enabled-Roaming makes up 1% of the culture profiles assessed by the users. The second modality of weighting the sixteen total combinations may be in an order that designates how much effort and investment there may be to evolve each profile to a fully remote ready profile (4-4). For example, when weighing these profiles, it may be important for the system to weigh them by both the weighted combination (e.g., 0-4, 1-4, 2-4, 3-4, 4-4, making up the different vertical “levels”), as well as weighing the combinations on the same level (e.g., 2-4) according to their varying degrees of difficulty associated with improving. For example, with reference to level 2-4, the culture profiles with both the “foundational” dimensions (Leadership and Organization) indicated as remote-ready may be visualized towards the right, as these profiles may be less challenging to improve than those that do not have the “foundational” dimensions developed. Also, the pairing of certain dimensions (foundational, embedded, people, environment) may be considered by the system when making recommendations, as discussed herein.

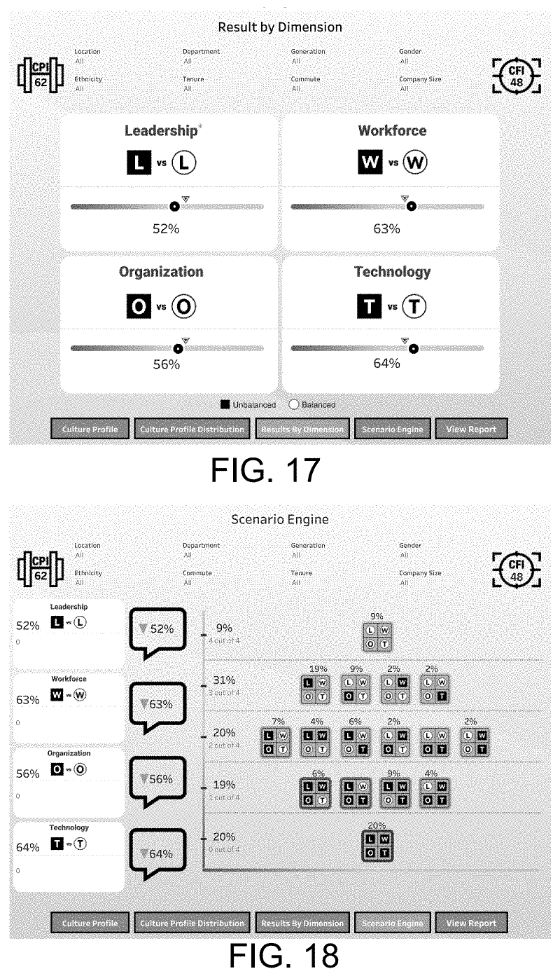

FIG. 17 illustrates an example presentation of workplace, according to an embodiment. For example, in some embodiments and with reference to FIG. 17, each of the four individual dimensions may be presented as a positioning of the cumulative user profiles in each dimension. In some embodiments, this cumulative positioning may be based on averages of all user culture profiles (or, e.g., all user culture profiles for a selected segment of the organization, filtered as described herein). As shown in the example of FIG. 17, a cumulative user profile of each of the four dimensions of Leadership, Workforce, Organization, and Technology is displayed as a singular culture profile for the organization. In the illustrated example, the organization (as a whole or as filtered) has a Trusting-Managed-Structured-Roaming culture profile. Together with this visualization, the system may be able to make observations for the client. For example, the system may note that Technology is only at 64% Roaming, but that this may be because Workforce is only at 63% —in other words, the users are not being adequately enabled, so they lack clarity on what technology to use, how to use it, what training is available, etc. Other observations may be made by the system based on its understanding (which may be learned, e.g., through AI/ML) of the correlations between each dimension.

FIG. 18 illustrates an example scenario engine, according to an embodiment. Particularly, FIG. 18 may illustrate a sorting of culture profiles in a workplace based on the four dimensions.

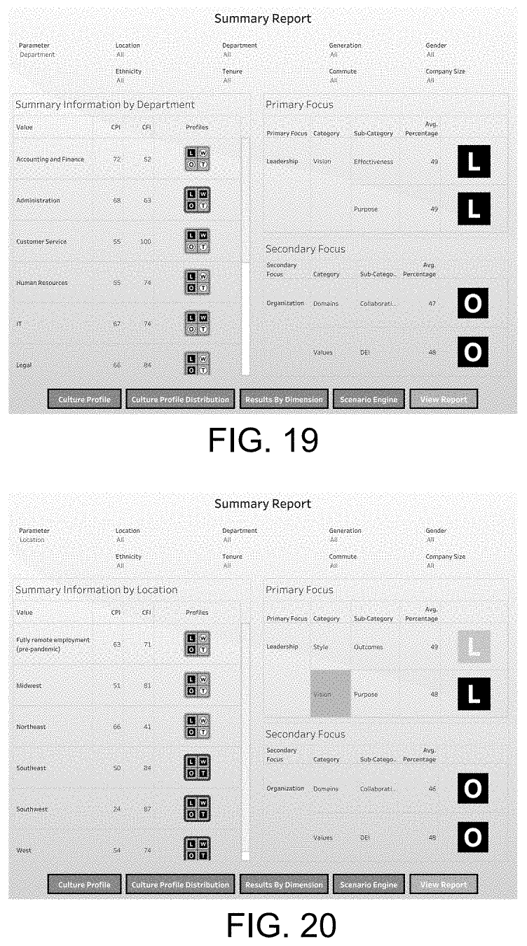

FIG. 19 and FIG. 20 illustrate an example summary report, according to an embodiment. The example summary report may provide, for example, summary information on profiles by department, location, or generation, as well as a primary focus and a secondary focus for improvement of workplace culture.

Embodiments may implement machine learning, a type of artificial intelligence (AI) that provides computers with an ability to learn how to process data without being explicitly programmed. Machine learning focuses on the development of computer programs that can teach themselves to grow and change when exposed to new data. Machine learning explores the study and construction of algorithms that can learn from and make predictions based on data. Such algorithms may overcome following strictly static program instructions by making data-driven predictions or decisions, through building a model from sample inputs.

Machine learning may refer to a variety of AI software algorithms, which may be used to perform supervised learning, unsupervised learning, reinforcement learning, deep learning, or any combination thereof. A variety of different machine learning algorithms may be employed in embodiments. Examples of machine learning algorithms may include, inter alia, artificial neural network algorithms, Gaussian process regression algorithms, fuzzy logic-based algorithms, or decision tree algorithms.

In some embodiments, more than one machine learning algorithm may be employed. For example, automated classification may be implemented using one type of machine learning algorithm, and adaptive real-time process control may be implemented using a different type of machine learning algorithm. In some embodiments, hybrid machine learning algorithms including features and properties drawn from two, three, four, five, or more different types of machine learning algorithms may be employed in embodiments.

Supervised learning algorithms may use labeled training data to infer a relationship between one or more identifiable aspects of a given entity and a classification of the entity according to a specified set of criteria or to infer a relationship between input process control parameters and desired outcomes. The training data may include paired training examples. For example, each training data example may include aspects identified for a given entity and the resultant classification of the given entity. As a further example, each training data example may include process control parameters used in a process and a known outcome of the process.

Unsupervised learning algorithms may be used to draw inferences from training data including entity data not paired with labeled entity classification data, or input process control parameter data not paired with labeled process outcomes. An example unsupervised learning algorithm is cluster analysis, which may be used for exploratory data analysis to find hidden patterns or groupings in process data.

Semi-supervised learning algorithms may use both labeled and unlabeled object classification or process data for training Semi-supervised learning algorithms may typically use a small amount of labeled data with a large amount of unlabeled data.

Reinforcement learning algorithms may be used, for example, to optimize a process (e.g., steps or actions of the process) to maximize a process reward function or minimize a process loss function. In machine learning environments, reinforcement learning algorithms may be formulated as Markov decision processes. Reward functions or loss functions, which may also be referred to as cost functions or error functions, may map values of one or more process variables and/or outcomes to a real number that represents a reward or cost, respectively, associated with a given process outcome or event. Examples of process parameters and process outcomes include, inter alia, process throughput, process yield, production quality, or production cost. In some cases, the definition of the reward or loss function to be maximized or minimized, respectively, may depend on the choice of machine learning algorithm used to run the process control method, or vice versa. For example, if an objective is to maximize a total reward/value function, a reinforcement learning algorithm may be chosen. If the objective is to minimize a mean squared error loss function, a decision tree regression algorithm or linear regression algorithm may be chosen. In general, the machine learning algorithm used to run the process control method will seek to optimize the reward function or minimize the loss function by identifying the current state of the process; comparing the current state to the reference state, which may be a target intermediate or final state; and adjusting one or more process control parameters to minimize a difference between the two states. This adjustment may include reference to past learning provided by a training data set. Reinforcement learning algorithms differ from supervised learning algorithms in that correct training data input/output pairs are not presented, nor are sub-optimal actions explicitly corrected. Implementations of these algorithms tend to focus on real-time performance by finding a balance between exploration of possible outcomes based on updated input data and exploitation of past training.

Deep learning, which may also be known as deep structured learning, hierarchical learning, or deep machine learning, may be based on a set of algorithms that attempt to model high level abstractions in data. Deep learning algorithms may be inspired by the structure and function of the human brain and is part of a broader family of machine learning methods based on learning representations of data. Rooted in neural network technology, deep learning may involve a probabilistic graph model having many neuron layers, commonly known as a deep architecture. Deep learning technology may process information such as, inter alia, image, text, or sound information in a hierarchical manner. An observation (e.g., a feature to be extracted for reference) can be represented in many ways including, for example, a vector of intensity values, a set of edges, regions of shape, or in another abstract manner. Some representations may simplify the learning task (e.g., face recognition or facial expression recognition). Deep learning can provide efficient algorithms for unsupervised or semi-supervised feature learning and hierarchical feature extraction. Embodiments employing deep learning can further benefit from the advantage of deep learning concepts in solving a normally intractable representation inversion problem.

A deep learning module may be configured as a neural network. The deep learning module may further be a deep neural network with a set of weights that model the world based on training using training data. Neural networks can be understood to implement a computational approach-based on a relatively large collection of neural units—to loosely model the way a human brain solves problems with large clusters of biological neurons connected by axons. Each neural unit may be connected to one or more others, and links can be enforcing or inhibitory in their effect on the activation state of connected neural units. These systems may be self-learning and trained rather than explicitly programmed. Neural network systems excel in areas where a solution or feature detection is difficult to express in a traditional computer program.

An example of a deep learning algorithm may be an artificial neural network (ANN). Large ANNs including many layers may be used, for example, to map entity data to entity classification decisions or to map input process control parameters to desired process outcomes. ANNs will be discussed in further detail below.

Neural networks typically include multiple layers, and the signal path may traverse from front to back. The goal of neural networks may be to solve problems in a similar manner to the human brain, although several neural networks may be much more abstract. In a simple example of a neural network, there may be two layers (i.e., sets) of neurons: an input layer that receives an input signal and an output layer that sends an output signal. When the input layer receives an input, it may pass a modified version of the input to the next layer. In a deep network, there may be many layers between the input layer and output layer, allowing the algorithm to use multiple processing layers, which may include multiple linear and non-linear transformations. Modern neural networks typically work with a few thousand to a few million neural units and millions of connections. Neural networks may have various suitable architectures and/or configurations known in the art.

There are many variants of neural networks with deep architecture depending on the probability specification and network architecture, including, inter alia, deep belief networks (DBN), restricted Boltzmann machines (RBM), random forests, and autoencoders. Implementations of neural networks may vary depending on the size of input data, the number of features to be analyzed, and the nature of the problem. Other layers may be included in the deep learning module besides the neural networks disclosed herein.

Another type of deep neural network may be a convolutional neural network (CNN), which can be used for analysis of an entity or process. CNNs are commonly composed of layers of different types: convolution, pooling, upscaling, and fully connected layers. In some cases, an activation function such as a rectified linear unit (ReLU) function may be used in some of the layers. In a CNN architecture, there can be one or more layers for each type of operation performed. A CNN architecture may include any number of layers in total, and any number of layers for the different types of operations performed. The simplest CNN architecture starts with an input layer followed by a sequence of convolutional layers and pooling layers (e.g., layers otherwise configured for reducing the dimensionality of the feature map generated by the one or more convolutional layers while retaining the most important features, for example, max pooling layers) and ends with fully connected layers (e.g., a layer in which each of the nodes is connected to each of the nodes in the previous layer). Each convolution layer may include a plurality of parameters used for performing the convolution operations. Each convolution layer may also include one or more filters, which in turn may include one or more weighting factors or other adjustable parameters. In some instances, the parameters may include biases (e.g., parameters that permit an activation function to be shifted). In some cases, the convolutional layers may be followed by an ReLU activation function layer. Other activation functions can also be used, for example, inter alia, saturating hyperbolic tangent, identity, binary step, logistic, arctan, softsign, parametric rectified linear unit, exponential linear unit, softPlus, bent identity, softExponential, Sinusoid, Sinc, Gaussian, or sigmoid functions. The convolutional, pooling and ReLU layers may function as learnable feature extractors, while the fully connected layers may function as machine learning classifiers. As with other artificial neural networks, the convolutional layers and fully connected layers of CNN architectures may include various computational parameters, for example, weights, bias values, and threshold values, which may be trained in a training phase.

Another type of deep neural network may be a visual geometry group (VGG) network. For example, VGG networks may be created by increasing the number of convolutional layers while fixing other parameters of the architecture. Adding convolutional layers to increase depth may be made possible by using substantially small convolutional filters in all of the layers. VGG networks may also include convolutional layers followed by fully connected layers.

Another type of deep neural network may be a deep residual network. Like some other networks described herein, a deep residual network may include convolutional layers followed by fully connected layers, which may be, in combination, configured and trained for feature property extraction. A deep residual network's layers may be configured to learn residual functions with reference to layer inputs, instead of learning unreferenced functions. Instead of relying on a direct fit of few stacked layers to a desired underlying mapping, a deep residual network's layers may be explicitly allowed to fit a residual mapping, which may be realized by feedforward neural networks having shortcut connections (i.e., connections that skip one or more layers). A deep residual network may be created by inserting shortcut connections into a plain neural network structure including convolutional layers, thereby modifying the plain neural network into a residual learning network.

In some embodiments, the machine learning module may include a support vector machine (SVM), an artificial neural network (ANN), a decision tree-based expert learning system, an autoencoder, a clustering machine learning algorithm, or a nearest neighbor (e.g., kNN) machine learning algorithm, or combinations thereof, some of which will be described in further detail below.

Support vector machines (SVMs) may be supervised learning algorithms used for classification and regression analysis of entity classification data or process control. Given a set of training data examples (e.g., entity or process data), each marked as belonging to a category, an SVM training algorithm may build a model that assigns new examples (e.g., data from a new entity or process) to a given category.

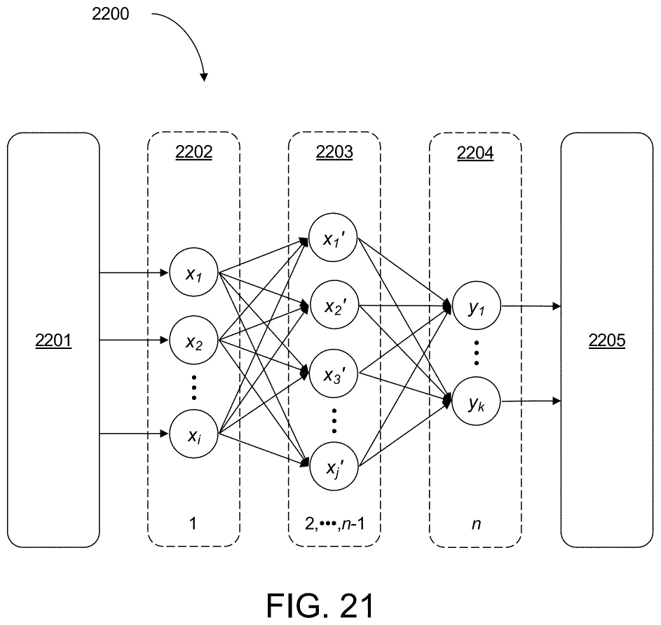

FIG. 21 illustrates an artificial neural network (ANN) 2200, according to an embodiment. ANN 2200 may be used for, inter alia, classification or process control optimization according to various embodiments.

ANN 22100 may include any type of neural network module, such as, inter alia, a feedforward neural network, radial basis function network, recurrent neural network, or convolutional neural network.

In embodiments implementing ANN 2200 for entity classification, ANN 2200 may be employed to map entity data to entity classification data. In embodiments implementing ANN 2200 for process optimization, ANN 2200 may be employed to determine an optimal set or sequence of process control parameter settings for adaptive control of a process in real-time based on a stream of process monitoring data and/or entity classification data provided by, for example, observation or from one or more sensors. ANN 2200 may include an untrained ANN, a trained ANN, pre-trained ANN, a continuously updated ANN (e.g., an ANN utilizing training data that is continuously updated with real time classification data or process control and monitoring data from a single local system, from a plurality of local systems, or from a plurality of geographically distributed systems).

ANN 2200 may include interconnected nodes (e.g., x₁—xᵢ, x₁′-xⱼ′, and y₁-yₖ) organized into n layers of nodes, where x₁-xᵢ represents a group of i nodes in a first layer 2202 (e.g., layer 1), x₁′-xᵢ′ represents a group of j nodes in a hidden layer 2203 (e.g., layer(s) 2 through n−1), and y₁-yₖ represents a group of k nodes in a final layer 2204 (e.g., layer n). Input layer 2202 may be configured to receive input data 2201 (e.g., sensor data, image data, sound data, observed data, automatically retrieved data, manually input data, etc.). Final layer 2204 may be configured to provide result data 2205.

There may be one or multiple hidden layers 2203, and the number j of nodes in each hidden layer 2203 may vary from embodiment to embodiment. Thus, ANN 2200 may include any total number of layers (e.g., any number of hidden layers 2203). One or more of hidden layers 2203 may function as trainable feature extractors, which may allow mapping of input data 2201 to preferred result data 2205.

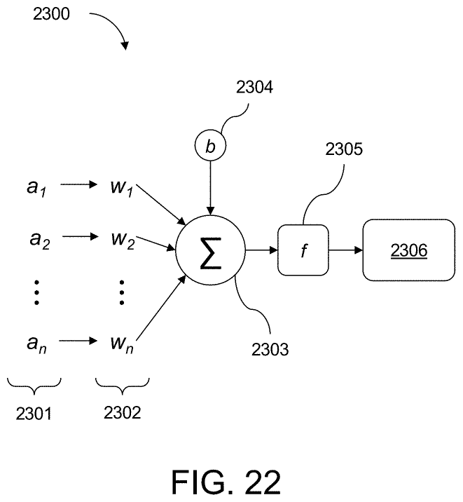

FIG. 22 illustrates a node 2300, according to an embodiment. Each layer of a neural network may include one or more nodes similar to node 2300, for example, nodes x₁-xᵢ, x₁′-xⱼ′, and y₁-yₖ depicted in FIG. 21. Each node may be analogous to a biological neuron.

Node 2300 may receive node inputs 2301 (e.g., a₁-aₙ) either directly from the ANN's input data (e.g., input data 2201) or from the output of one or more nodes in a different layer or the same layer. With node inputs 2301, the node 2300 may perform an operation 2303, which while depicted in FIG. 22 as a summation operation, would be readily understood to include various other operations known in the art.

In some cases, node inputs 2301 may be associated with one or more weights 2302 (e.g., w₁-wₙ), which may represent weighting factors. For example, operation 2303 may sum the products of each of node inputs 2301 and associated weights 2302 (e.g., aᵢwᵢ).

The result of operation 2303 may be offset with a bias 2304 (e.g., bias b), which may be a value or a function.

Output 2306 of node 2300 may be gated using an activation (or threshold) function 2305 (e.g., function ƒ), which may be a linear or a nonlinear function. Activation function 2305 may be, for example, a ReLU activation function or other function such as a saturating hyperbolic tangent, identity, binary step, logistic, arctan, softsign, parametric rectified linear unit, exponential linear unit, softPlus, bent identity, softExponential, Sinusoid, Sinc, Gaussian, or sigmoid function, or any combination thereof.

Weights 2302, biases 2304, or threshold values of activation functions 2305, or other computational parameters of the neural network, can be “taught” or “learned” in a training phase using one or more sets of training data. For example, the parameters may be trained using input data from a training data set and a gradient descent or backward propagation method so that the output value(s) (e.g., a set of predicted adjustments to classification or process control parameter settings) computed by the ANN may be consistent with the examples included in the training data set. The parameters may be obtained, for example, from a back propagation neural network training process, which may or may not be performed using the same hardware as that used for automated classification or adaptive, real-time deposition process control.

Decision tree-based expert systems may be supervised learning algorithms designed to solve entity classification problems or process control problems by applying a series of conditional (e.g., if-then) rules. Expert systems may include two subsystems: an inference engine and a knowledge base. The knowledge base may include a set of facts (e.g., a training data set including entity data for a series of entities, and the associated entity classification data provided by, for example, a skilled operator, technician, or inspector) and derived rules (e.g., derived entity classification rules). The inference engine may then apply the rules to input data for a current entity classification problem or process control problem to determine a classification of the entity or a next set of process control adjustments.

Autoencoders (also sometimes referred to as an auto-associator or Diabolo network), may be an ANN used for unsupervised and efficient mapping of input data (e.g., entity data or process data), to an output value (e.g., an entity classification or optimized process control parameters). Autoencoders may be used for the purpose of dimensionality reduction, that is, a process of reducing the number of random variables under consideration by deducing a set of principal component variables. Dimensionality reduction may be performed, for example, for the purpose of feature selection (e.g., selecting a subset of the original variables) or feature extraction (e.g., transforming of data in a high-dimensional space to a space of fewer dimensions).

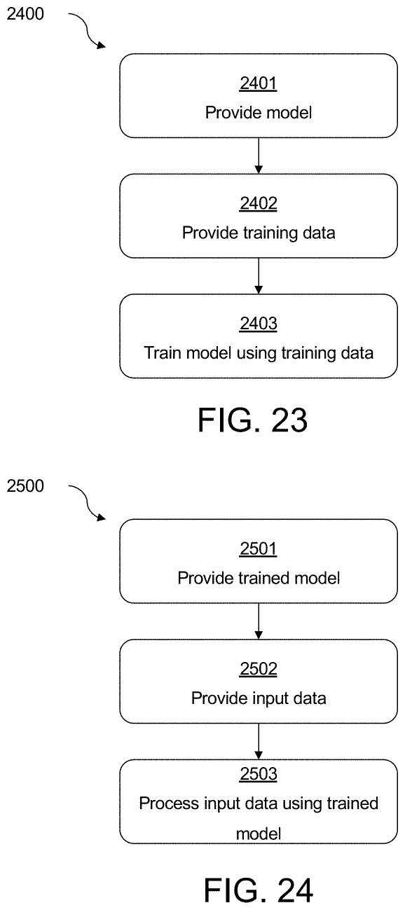

FIG. 23 illustrates a method 2400 of training a machine learning model of a machine learning module, according to an embodiment. Use of method 2400 may provide for use of training data to train a machine learning model for concurrent or later use.

At 2401, a machine learning model including one or more machine learning algorithms may be provided.

At 2402, training data may be provided. Training data may include one or more of process simulation data, process characterization data, in-process or post-process inspection data (including inspection data provided by a skilled operator and/or inspection data provided by any of a variety of automated inspection tools), or any combination thereof, for past processes that are the same as or different from that of the current process. One or more sets of training data may be used to train the machine learning algorithm used for object defect detection and classification. In some cases, the type of data included in the training data set may vary depending on the specific type of machine learning algorithm employed.

At 2403, the machine learning model may be trained using the training data. For example, training the model may include inputting the training data to the machine learning model and modifying one or more parameters of the model until the output of the model is the same as (or substantially the same as) external validation data. Model training may generate one or more trained models. One or more trained models may be selected for further validation or deployment, which may be performed using validation data. The results produced by each trained model for the validation data input to the training model may be compared to the validation data to determine which of the models is the best model. For example, the trained model that produces results most closely matching the validation data may be selected as the best model. Test data may then be used to evaluate the selected model. The selected model may also be sent to model deployment in which the best model may be sent to the processor for use in a post-training mode.

FIG. 24 illustrates a method 2500 of analyzing input data using a machine learning module, according to an embodiment. Use of the machine learning module described by method 2500 may enable, for example, automatic classification of an entity or optimized process control.

At 2501, a trained machine learning model may be provided to the machine learning module. The trained machine learning model may have been trained, or under continuous or periodic training by one or more other systems or methods. The machine learning model may be pre-generated and trained, enabling functionality of the module as described herein, which can then be used to perform one or more post-training functions of the machine learning module.

For example, the provided trained machine learning model may be similar to ANN 2200, include nodes similar to node 2300, and may have been trained (or be under continuous or periodic training) using a method similar to method 2400.

At 2502, input data may be provided to the machine learning module for input into the machine learning model. The input data may result from or be derived from a variety of different sources, similar to input data 2201.

The provision of input data at 2502 may further include removing noise from the data prior to providing it to the machine learning algorithm. Examples of data processing algorithms suitable for use in removing noise from the input data may include, inter alia, signal averaging algorithms, smoothing filter algorithms, Kalman filter algorithms, nonlinear filter algorithms, total variation minimization algorithms, or any combination thereof.

The provision of input data at 2502 may further include subtraction of a reference data set from the input data to increase contrast between aspects of interest of an entity or process and those not of interest, thereby facilitating classification or process control optimization. For example, a reference data set may include input data for a real or contrived ideal example of the entity or process. If an image sensor or machine vision system is used for entity observation, the reference data set may include an image or set of images (e.g., representing different views) of an ideal entity.

At 2503, the machine learning module may process the input data using the trained machine learning model to yield results from the machine learning module. Such results may include, for example, an entity classification or one or more optimized process control parameters.

Additionally, in embodiments, the system may have a default for the weighting of each location, department, group, role, tenure, etc. for its viability to be fully virtual, hybrid or fully physical. For example, for users in the IT Department, their responses regarding the Technology dimension may be weighted less by the system because their perspective and/or familiarity with the organization's technology is skewed. The system may also offer the client the ability to provide their own weighting of each department, group, etc., for its viability to be fully virtual, hybrid or fully physical. These weightings may be considered by the system in making the recommendations. Also, in embodiments, the client may be able to weight different departments, groups, etc., of an organization as roles that they believe may be successful in a fully remote or hybrid realm. For example, a client may rate sales as a highly remote role. The system may then use its default recommendations to inform the client of if and how the sales team is currently positioned to be productive in a remote and/or hybrid realm. Then, the system may inform the client of how it can better position the recommendations to be more productive. In some embodiments, the system may inform the client of exactly what needs to be changed and may provide the client of the order in which to make these changes.

In some embodiments, the system may provide for the client to define user profiles based on the variables such as location, department, group, role, tenure, etc. The user profiles may also be defined by the client according to their hypothetical positionings in each of the four dimensions. Also, the system may provide for the client to ascribe certain numbers or percentages of hypothetical users to these user profiles. These user profiles may be used by the system in the assessments and recommendations described herein. Thus, the system may provide for the client to plan ahead with the use of hypothetical users via these user profiles, such as for a new business, or when adding a new department, group, location, etc.

In embodiments, the client may also have the option to make the assessment an ongoing probe by the system. Based on both prior assessment answers from each respective user as well as the automated recommendations, the assessment may self-identify additional statements and/or question for each user (possibly using AI/ML). These newly generated statements and answers may inform the client where else to focus resources, effort, and investment to support users across all realms (physical, hybrid, and virtual), as well as understand how effective the recommended changes have been.

The client may have the ability to leverage the system to understand how any particular worker, group, department, location, etc. is currently being supported, and the system's recommendations to evolve that support based on where/how they will be working across all realms—physical, hybrid, virtual. This may allow the client to allocate the appropriate workplace square footage and the culture of support for all workers to promote productivity and retain talent.

The above system according to embodiments describes a culture engine in support of, e.g., a main corporate real estate (CRE) module. In essence, the system's culture engine may be leveraged to help corporate entities determine how to invest appropriately in providing a physical workplace that can support the business needs and the appropriate segment of the workforce. The system may also automate the process for corporate entities to understand how to calibrate their culture in order to support not only those workers working from the physical workplace, but also those who are stationed remotely on a fulltime basis or a parttime basis (hybrid). The system's culture engine may drive a business' ability to support its worker productivity, as well as to build and maintain the practices that will retain and attract top talent.

Additionally, in some embodiments, the culture engine may support or include two other modules of the system that may be leveraged for other needs of a corporate entity, including a corporate information technology (IT) module and a corporate HR module.

The corporate IT module may use artificial intelligence (AI) of the system, in some embodiments including machine learning (ML), to determine what type of support resources to allocate across any given business. Via the assessment answers, filters, the rule-based hierarchy of culture profiles, the ability of the system to identify follow-on questions, etc., as may be employed by AI/ML, the recommendations of support resources may enable crowd-sourced needs, thus lowering costs, reducing change management needs, and intelligently applying the right resources to the right needs.

The human resources (HR) module may identify individuals, groups, departments, and locations of culture profiles. In some embodiments, the HR module may perform this identification using AI/ML of the system. Additionally, another input to the HR module which may be used for identification may be the status of employees as they start their employment with a client firm or exit the client firm. In some embodiments, a purpose of the HR module may be to provide HR support and resources to meet the needs of workers as well as identify and attract culture profiles associated with long-term workers as well as those that resign. The culture engine may then have the ability to determine and ask follow-up questions based on prior answers provided by users. Further, the culture engine may identify when the culture profile may better resemble that of a long-term employee, and/or identify a culture profile associated with high rate of resignations for any person, group, department, or location.

In embodiments, an algorithm used by the system, as may be implemented by AI/ML, may not only leverage data collected by the assessment and applied to the culture engine (e.g., the hierarchy of rules for individual dimensions and culture profiles, past assessment answers for workers identified as longstanding, productive, struggling or former workers (those that resigned), etc.), but may also leverage data from other systems such as security badge data, communications platforms such as Microsoft communication platforms, HR systems such as Workday, corporate communications platforms, etc. This may enable the system to make extremely specific recommendations to evolve a culture, provide resources to the right issues across an entire company, and be extremely efficient and effective with budgeting and meeting worker needs.

In embodiments, the system may provide rough order of magnitude costs per recommendation. In an example, the system may leverage publicly available data for the costs associated with resources, equipment, systems, etc., in any given location around the world. The system may match this information with the recommendations and provide the associated rough order of magnitude costs.

In embodiments, the system may also make observations of common issues specific to each of the four dimensions and make recommendations based on the specific issues. Examples of recommendations may include training for managers/leaders based on consistent assessment feedback in the Leadership dimension, education, and training for a new/better annual review process because of assessment feedback in the Talent dimension, access to better office space for those working from home in areas with lesser bandwidth capabilities, etc. The system may do this by aligning filtered data with tagged data from statements/questions that are consistently showing as an area that may need to be addressed. [0045] In embodiments, the system may use real-world data to verify assessment results and improve assessment data. For example, the system may use network traffic information, badge swipes, etc., of users to determine how much of that time the users really were working remotely, versus in the office, who is actually hybrid. This may be cross-checked with data regarding power consumption, heating, etc., and other environmental data from sensors. Real-world data may be used to scale (e.g., weight) the assessment answers from users—e.g., to up-rate them, down-rate them, put a multiplier on them, or throw them out. Further, for example, the system may track usage of different applications to predict a user's answers to certain assessment statements.

In embodiments, the system may continually update an organization's culture profile as it gathers new or updated assessments from users and make recommendations thereto. Also, in embodiments, the system may use AI/ML to continuously optimize its culture profile assessment using rules, constraints, and real-world data. This use of data may imbue the system with trusted objectivity, as it may rely on data rather than human analysis to predict outcomes. Furthermore, as the system continues to be used by more and more organizations, it may be able to show past predictions and outcomes as an indication of future success in its predictions, as well as learn and provide the estimated costs of improving a cultural dimension for an organization with a given make-up (e.g., location(s), departments, generations, tenures, etc.).

Various characteristics, advantages, embodiments, and/or examples relating to the invention have been described in the foregoing description with reference to the accompanying drawings. However, the above description and drawings are illustrative only. The invention is not limited to the illustrated embodiments and/or examples, and all embodiments and/or examples of the invention need not necessarily achieve every advantage or purpose, or possess every characteristic, identified herein. Accordingly, various changes, modifications, or omissions may be effected by one skilled in the art without departing from the scope or spirit of the invention, which is limited only by the appended claims. Although example materials and dimensions have been provided, the invention is not limited to such materials or dimensions unless specifically required by the language of a claim. Elements and uses of the above-described embodiments and/or examples can be rearranged and combined in manners other than specifically described above, with any and all permutations within the scope of the invention, as limited only by the appended claims.

In the claims, various portions are prefaced with letter or number references for convenience. However, use of such references does not imply a temporal or ordered relationship not otherwise required by the language of the claims. Unless the phrase ‘means for’ or ‘step for’ appears in a particular claim or claim limitation, such claim or sample claim limitation should not be interpreted to invoke 35 U.S.C. § 112(f).

As used in the specification and in the claims, use of “and” to join elements in a list forms a group of all elements of the list. For example, a list described as comprising A, B, and C defines a list that includes A, includes B, and includes C. As used in the specification and in the claims, use of “or” to join elements in a list forms a group of at least one element of the list. For example, a list described as comprising A, B, or C defines a list that may include A, may include B, may include C, may include any subset of A, B, and C, or may include A, B, and C. Unless otherwise stated, lists herein are inclusive, that is, lists are not limited to the stated elements and may be combined with other elements not specifically stated in a list. As used in the specification and in the claims, the singular form of ‘a’, ‘an’, and ‘the’ include plural referents (e.g., one or more of the referent) unless the context clearly dictates otherwise.

It is to be expressly understood that the drawings are for the purpose of illustration and description only and are not intended as a definition of the limits of the invention.

It is to be expressly understood that the drawings are for the purpose of illustration and description only and are not intended as a definition of the limits of the invention.

Unless otherwise stated, any range of values disclosed herein sets out a lower limit value and an upper limit value, and such ranges include all values and ranges between and including the limit values of the stated range, and all values and ranges substantially within the stated range as defined by the order of magnitude of the stated range.

The inventors hereby state their intent to rely on the Doctrine of Equivalents to determine and assess the reasonably fair scope of their invention as pertains to any apparatus not materially departing from but outside the literal scope of the invention as set out in the following claims.

I claim:

1. A method of training a remote workplace culture assessment model, comprising, using a processor of an application server:
providing the remote workplace culture assessment model comprising a neural network comprising a logical connection connecting:
a user response input;
a test statement input;
a weighting input;
a statement strength output;
a statement correlation output;
a remote workplace culture profile output; and
wherein the neural network is configured to be trained by changing the weighting input;
sending an assessment to a user device corresponding to a user of a workplace, the assessment including a test statement;
receiving, from the user device, a user response to the test statement;
applying the user response to the user response input of the remote workplace culture assessment model and the test statement to the test statement input of the remote workplace culture assessment model, thereby yielding a statement strength at the statement strength output, a statement correlation at the statement correlation output, and a remote workplace culture profile at the remote workplace culture profile output; and
changing the weighting input of the remote workplace culture assessment model based on the statement strength and the statement correlation, thereby training the remote workplace culture assessment model.

2. The method of claim 1, wherein the remote workplace culture profile output is configured to include one or more culture dimensions.

3. The method of claim 2, wherein the culture dimensions include leadership, organization, workforce, and technology.

4. The method of claim 1, further comprising,
with one or more additional user devices, each additional user device corresponding to an additional user, using the processor:
sending an additional assessment to each additional user device, the additional assessment including an additional test statement;
receiving, from each of the one or more additional user devices, an additional user response to the additional test statement; and
applying each additional user response to the user response input of the remote workplace culture assessment model and each additional test statement to the test statement input of the remote workplace culture assessment model, thereby yielding one or more additional statement strengths at the statement strength output, one or more additional statement correlations at the statement correlation output, and one or more additional remote workplace culture profiles at the remote workplace culture profile output; and
changing the weighting input of the remote workplace culture assessment model based on the one or more additional statement strengths and the one or more additional statement correlations, thereby training the remote workplace culture assessment model.

5. The method of claim 4, further comprising weighting the remote workplace culture profile and the one or more additional remote workplace culture profiles to determine a cumulative culture profile of the workplace.

6. The method of claim 5, further comprising composing a cumulative culture profile visualization based on the cumulative culture profile of the workplace.

7. The method of claim 1, further comprising, based on the remote workplace culture assessment model, providing a recommendation to improve the workplace for remote work.

8. The method of claim 7, wherein the recommendation is associated with one or more culture dimensions.

9. A system for training a remote workplace culture assessment model, comprising:
a processor of an application server; and
an electronic storage device in electronic communication with the processor, the electronic storage device having a database stored thereon;
wherein the processor is configured to perform a method comprising:
provide the remote workplace culture assessment model comprising a neural network comprising a logical connection connecting:
a user response input;
a test statement input;
a weighting input;
a statement strength output;
a statement correlation output;
a remote workplace culture profile output; and
wherein the neural network is configured to be trained by changing the weighting input;
send an assessment to a user device corresponding to a user of a workplace, the assessment including a test statement;
receive, from the user device, a user response to the test statement;
apply the user response to the user response input of the remote workplace culture assessment model and the test statement to the test statement input of the remote workplace culture assessment model, thereby yielding a statement strength at the statement strength output, a statement correlation at the statement correlation output, and a remote workplace culture profile at the remote workplace culture profile output; and
change the weighting input of the remote workplace culture assessment model based on the statement strength and the statement correlation, thereby training the remote workplace culture assessment model.

10. The system of claim 9, wherein the remote workplace culture profile output is configured to include one or more culture dimensions.

11. The system of claim 10, wherein the culture dimensions include leadership, organization, workforce, and technology.

12. The system of claim 9, wherein the method further comprises,
with one or more additional user devices, each additional user device corresponding to an additional user, using the processor:
sending an additional assessment to each additional user device, the additional assessment including an additional test statement;
receiving, from each of the one or more additional user devices, an additional user response to the additional test statement; and
applying each additional user response to the user response input of the remote workplace culture assessment model and each additional test statement to the test statement input of the remote workplace culture assessment model, thereby yielding one or more additional statement strengths at the statement strength output, one or more additional statement correlations at the statement correlation output, and one or more additional remote workplace culture profiles at the remote workplace culture profile output; and
changing the weighting input of the remote workplace culture assessment model based on the one or more additional statement strengths and the one or more additional statement correlations, thereby training the remote workplace culture assessment model.

13. The system of claim 12, wherein the method further comprises weighting the remote workplace culture profile and the one or more additional remote workplace culture profiles to determine a cumulative culture profile of the workplace.

14. The system of claim 13, wherein the method further comprises composing a cumulative culture profile visualization based on the cumulative culture profile of the workplace.

15. The system of claim 9, wherein the method further comprises, based on the remote workplace culture assessment model, providing a recommendation to improve the workplace for remote work.

16. The system of claim 15, wherein the recommendation is associated with one or more culture dimensions.

17. A tangible, non-transient, computer-readable media having instructions thereupon which when implemented by a processor cause the processor to perform a method for training a remote workplace culture assessment model, the method comprising:
providing the remote workplace culture assessment model comprising a neural network comprising a logical connection connecting:
a user response input;
a test statement input;
a weighting input;
a statement strength output;
a statement correlation output;
a remote workplace culture profile output; and
wherein the neural network is configured to be trained by changing the weighting input;
sending an assessment to a user device corresponding to a user of a workplace, the assessment including a test statement;
receiving, from the user device, a user response to the test statement;
applying the user response to the user response input of the remote workplace culture assessment model and the test statement to the test statement input of the remote workplace culture assessment model, thereby yielding a statement strength at the statement strength output, a statement correlation at the statement correlation output, and a remote workplace culture profile at the remote workplace culture profile output; and
changing the weighting input of the remote workplace culture assessment model based on the statement strength and the statement correlation, thereby training the remote workplace culture assessment model.

18. The tangible, non-transient, computer-readable media of claim 17, wherein the method further comprises, with one or more additional user devices, each additional user device corresponding to an additional user, using the processor:
sending an additional assessment to each additional user device, the additional assessment including an additional test statement;
receiving, from each of the one or more additional user devices, an additional user response to the additional test statement; and
applying each additional user response to the user response input of the remote workplace culture assessment model and each additional test statement to the test statement input of the remote workplace culture assessment model, thereby yielding one or more additional statement strengths at the statement strength output, one or more additional statement correlations at the statement correlation output, and one or more additional remote workplace culture profiles at the remote workplace culture profile output; and
changing the weighting input of the remote workplace culture assessment model based on the one or more additional statement strengths and the one or more additional statement correlations, thereby training the remote workplace culture assessment model.

19. The tangible, non-transient, computer-readable media of claim 18, wherein the method further comprises weighting the remote workplace culture profile and the one or more additional remote workplace culture profiles to determine a cumulative culture profile of the workplace.

20. The tangible, non-transient, computer-readable media of claim 19, wherein the method further comprises composing a cumulative culture profile visualization based on the cumulative culture profile of the workplace.
